(19) United States
(12) Patent Application Publication
(10) Pub. No.: US 2004/0219305 A1
(43) Pub. Date: Nov. 4, 2004

(54) Retardation film and elliptically polarizing film

(75) Inventors: Hideyuki Nishikawa, Kanagawa (JP); Atsuhiro Ohkawa, Kanagawa (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Kanagawa (JP)

(21) Appl. No.: 10/777,167

(22) Filed: Feb. 13, 2004

(30) Foreign Application Priority Data
Feb. 13, 2003 (JP) P.2003-035454

(51) Int. Cl. C09K 19/00

(52) U.S. Cl. 428/1.2

(57) ABSTRACT

To provide a retardation film having an optically anisotropic layer where the direction having a minimum refractive index is substantially orthogonal to the normal direction of the film plane, by using a liquid crystal compound without performing a stretching operation, and also provide an elliptically polarizing film using the retardation film, a retardation film includes a transparent support having thereon at least one optically anisotropic layer, the optically anisotropic layer containing a layer formed of at least one liquid crystal compound, preferably a polymerizable compound or a polymer compound of expressing a biaxial liquid crystal phase. Furthermore, it is preferable that the retardation film include an alignment film and the alignment film contains a polymer having a hydrophobic group or an exclude-volume group.

### BACKGROUND OF THE INVENTION

1. Field of the Invention

The present invention relates to a retardation film (or retardation plate) having an optically anisotropic layer formed of a liquid crystal compound, especially a retardation film having an optically anisotropic layer formed of a biaxial liquid crystal compound, where the direction having a minimum refractive index (or smallest refractive index) of the optically anisotropic layer is substantially orthogonal to the normal direction in the film plane of the retardation film, and also relates to an elliptically polarizing film (or elliptically polarizing plate) using the retardation film.

2. Background Art

In general, an optically biaxial film is produced by biaxially stretching a film obtained from a polymer (see, for example, Background art 1: JP-A-2-264905 (the term “JP-A” as used herein means an “unexamined published Japanese patent application”)).

However, in recent years, a method of obtaining a biaxial film by using a biaxial liquid crystal has been proposed. The biaxial film using a liquid crystal, i.e., a compound exhibiting a liquid crystal phase is advantageous in that the film thickness can be made very small as compared with the biaxially stretched film conventionally used in many cases. Therefore, use of liquid crystal as a biaxial film is a very useful technique for realizing thinning, weight saving or the like of a device.

As for the biaxial film using the biaxial liquid crystal, a film produced by a method of uniaxially stretching a polymer liquid crystal compound of expressing an S_{CA} phase which is one of biaxial liquid crystal phases, has been reported (see, for example, Background art 2: JP-A-11-60972). In the biaxial film produced by this method, the optical property unobtainable in the above-described biaxial stretching of polymer, specifically, the useful optical property that the direction having a minimum refractive index is substantially orthogonal to the normal direction in the film plane (or surface), can be obtained. However, the film produced by utilizing the stretching is bad in the dimensional stability and often suffers from a situation that the optical performance is readily changed by humidity, heat or the like.

On the other hand, a technique where a biaxial film is produced by using a biaxial liquid crystal and not using stretching at all has been reported (see, for example, Background art 3: JP-A-2002-6138). However, this report is silent on the optical property that the direction having a minimum refractive index and the normal direction in the film plane are substantially orthogonal to each other. In other reported techniques using a biaxial liquid crystal (see, for example, Background art 4: JP-A-2002-174730), it is also not disclosed that the direction having a minimum refractive index and the normal direction in the film plane are substantially orthogonal to each other.

### SUMMARY OF THE INVENTION

An object of the present invention is to provide a retardation film having an optical property such that the direction having a minimum refractive index of the optically anisotropic layer is substantially orthogonal to the normal direction in the film plane, which can be produced by using a liquid crystal compound without performing a stretching operation, and also provide an elliptically polarizing film using the retardation film.

The above-described object can be attained by the following techniques.

(1) A retardation film comprising a transparent support having thereon at least one optically anisotropic layer, wherein said at least one optically anisotropic layer is formed of at least one compound exhibiting a liquid crystal phase, and shows biaxiality; and the direction with a smallest refractive index in the optically anisotropic layer (referred to as the “first direction”) is substantially orthogonal to a direction normal to the plane of the transparent support (referred to as the “normal direction”).

(2) The retardation film as described in (1) above, wherein the liquid crystal phase is a biaxial liquid crystal phase.

(3) The retardation film as described in (2) above, wherein the biaxial liquid crystal phase is a biaxial nematic liquid crystal phase.

(4) The retardation film as described in any one of (1) to (3) above, wherein the direction having a maximum (or largest) refractive index (referred to as the “second direction”) in the at least one optically anisotropic layer is substantially orthogonal to the normal direction of the transparent support.

(5) The retardation film as described in (4) above, wherein the angle between the direction having a minimum refractive index in the optically anisotropic layer (i.e., the first direction) and the normal direction of the transparent support is from 75 to 105° at both of the support-side interface (i.e., the interface which is nearer to the transparent support) and the air interface (i.e., the interface with air or the interface opposite to the support-side interface) in the optically anisotropic layer, and the angle between the direction having a maximum refractive index in the optically anisotropic layer (i.e., the second direction) and the normal direction of the transparent support is from 75 to 105° at both of the support-side interface and the air interface.

(6) The retardation film as described in any one of (2) to (5) above, wherein the compound exhibiting (or expressing) the biaxial liquid crystal phase is a polymerizable compound and/or a polymer (high molecular weight) compound.

(7) The retardation film as described in any one of (1) to (6), which comprises an alignment film between the transparent support and the at least one optically anisotropic layer.

(8) The retardation film as described in (7) above, wherein the alignment film contains a polymer having a hydrophobic group and/or an exclude-volume group.

(9) The retardation film as described in (8) above, wherein the alignment film is an acrylic or methacrylic acid copolymer comprising a repeating unit represented by the following formula (I) and a repeating unit represented by the following formula (II) or (III):

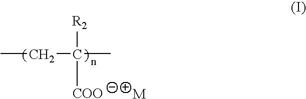

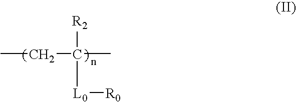

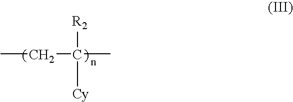

wherein R₁ represents a hydrogen atom or a methyl group, R₂ represents a hydrogen atom, a halogen atom or an alkyl group having from 1 to 6 carbon atoms, M represents a proton, an alkali metal ion or an ammonium ion, L₀ represents a divalent linking group selected from the group consisting of —O—, —CO—, —NH—, —SO₂—, an alkylene group, an alkenylene group, an arylene group and a combination thereof, R₀ represents a hydrocarbon group having from 10 to 100 carbon atoms or a fluorine atom-substituted hydrocarbon group having from 1 to 100 carbon atoms, C_{y} represents an aliphatic ring group, an aromatic group or a heterocyclic group, m is from 10 to 99 mol %, and n is from 1 to 90 mol %.

(10) An elliptically polarizing film having the retardation film described in any one of (1) to (9) above and a polarizing film.

The present invention can provide a retardation film having opticall properties that the optically anisotropic layer exhibits biaxiality without carrying out stretching by using a liquid crystal compound and the direction having a minimum refractive index in the optically anisotropic layer is substantially orthogonal to the normal direction of the film plane, and can provide an elliptically polarizing film using the retardation film.

### DETAILED DESCRIPTION OF THE INVENTION

The present invention is described in detail below. Liquid Crystal Compound:

The retardation film of the present invention includes at least one optically anisotropic layer formed of at least one compound exhibiting a liquid crystal (liquid crystal compound) on a transparent support. The liquid crystal phase may be a monoaxial liquid crystal phase or a biaxial liquid crystal phase, and is preferably a biaxial liquid crystal phase. The optically anisotropic layer of the present invention is formed by solidifying (or fixing) a liquid crystal compound in a state where it exhibits a liquid crystal phase. Accordingly, the case where the liquid crystal phase is a biaxial liquid crystal phase, that is, where a liquid crystal compound showing biaxiality is used, is preferable because it tends to easily form the optically anisotropic layer of the present invention. When a liquid crystal compound which does not show biaxiality by itself (such as a liquid crystal compound showing monoaxiality) is used, it is possible to form an optically anisotropic layer showing biaxiality by mixing two or more kinds of compounds.

Biaxial Liquid Crystal Compound:

The compound of exhibiting (or expressing) a biaxial liquid crystal phase, which is used for forming an optically anisotropic layer in the present invention, is a liquid crystal compound of optically exhibiting biaxiality. In other words, this is a liquid crystal compound where refractive indexes nx, ny and nz in three axial directions of the liquid crystal phase differ from each other and satisfy, for example, the relationship of nx>ny>nz.

The biaxial liquid crystal compound for use in the present invention preferably has the above-described property and at the same time, preferably exhibits good monodomain property so as to obtain uniform and defectless orientation (or alignment). If the monodomain property is bad, a polydomain structure results to cause orientation defects at the boundary between domains and, in turn, scattering of light. This disadvantageously gives rise to reduction in the transmittance of the retardation film. In the case of monoaxial liquid crystal compound for use in the present invention, it is preferable that the liquid crystal compound exhibits good monodomain property.

Examples of the biaxial liquid crystal phase exhibited by the liquid crystal compound for use in the present invention include biaxial nematic phase, biaxial smectic A phase and biaxial smectic C phase. Among these liquid crystal phases, a biaxial nematic phase (Nb phase) of exhibiting good monodomain property is preferred. The biaxial nematic phase is one of liquid crystal phases which can be taken by the nematic liquid crystalline compound, and this indicates a state such that when the space of a liquid crystal phase is defined by x axis, y axis and z axis, the liquid crystal compound (liquid crystalline molecule) is inhibited from free rotation of xz plane around y axis as the center and also from free rotation of xy plane around z axis as the center. The biaxial nematic phase is preferred because liquid crystalline molecules are easily oriented and orientation defects are less produced.

The liquid crystal compound for use in the present invention is a polymerizable compound and/or a polymer compound. The polymerizable compound may be a low molecular weight compound or a high molecular weight compound. The polymer compound is preferably a compound having polymerizability so as to perform the fixing of orientation, however, when the glass transition point is 30° C. or more, the polymer compound may not have polymerizability.

In the present invention, one kind of a biaxial liquid crystal compound may be used or two or more kinds of biaxial liquid crystal compounds may be used in combination. For example, a polymerizable biaxial liquid crystal compound and a non-polymerizable biaxial liquid crystal compound may be used in combination. Also, a low molecular weight liquid crystal compound and a polymer liquid crystal compound may be used in combination. Furthermore, a mixture of two or more biaxial liquid crystal compounds of not expressing a biaxial liquid crystal phase when used individually but expressing a biaxial liquid crystal phase when mixed may also be used.

Specific examples of the biaxial liquid crystal compound include the compounds described in Yuki Gosei Kagaku (Organic Synthesis Chemistry), Vol. 49, No. 5, pp. 124-143 (1991), and the compounds described in D. W. Bruce et al., AN EU-SPONSORED “OXFORD WORKSHOP ON BIAXIAL NEMATICS”, pp. 157-293, St Benet's Hall, University of Oxford (Dec. 20-22, 1996), S. CHANDRASEKHAR et al., A Thermotropic Biaxial Nematic Liquid Crystal; Mol. Cryst. Liq. Cryst., Vol. 165, pp. 123-130 (1988), and D. Demus, J. Goodby et al., Handbook of Liquid Crystals Vol. 2B: Low Molecular Weight Liquid Crystals II, pp. 933-943, WILEY-VCH. A polymerizable group may also be introduced into these compounds.

Examples of the low molecular weight liquid crystal compound having a polymerizable group, which can be used in the present invention, include the compounds described in paragraphs 0030 to 0032 of JP-A-2002-174730 (where examples of R include R₁ to R₃₉ (described in paragraphs 0034 to 0036)) and the oligomer liquid crystalline compounds described in paragraphs 0039 to 0040 of the same patent publication.

Other specific examples of the low molecular weight liquid crystal compound which can be preferably used in the present invention are set forth below, however, the present invention is not limited thereto.

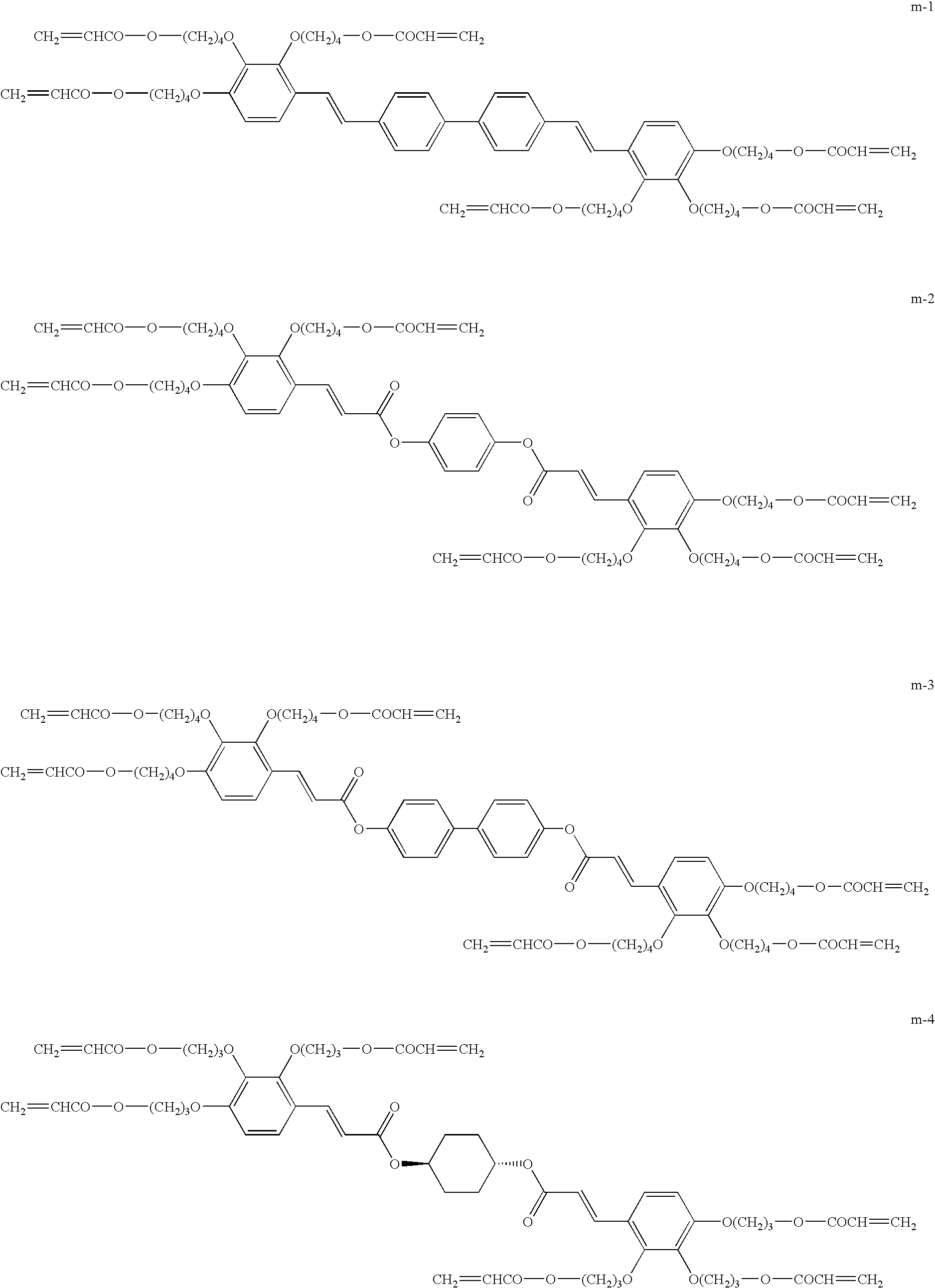

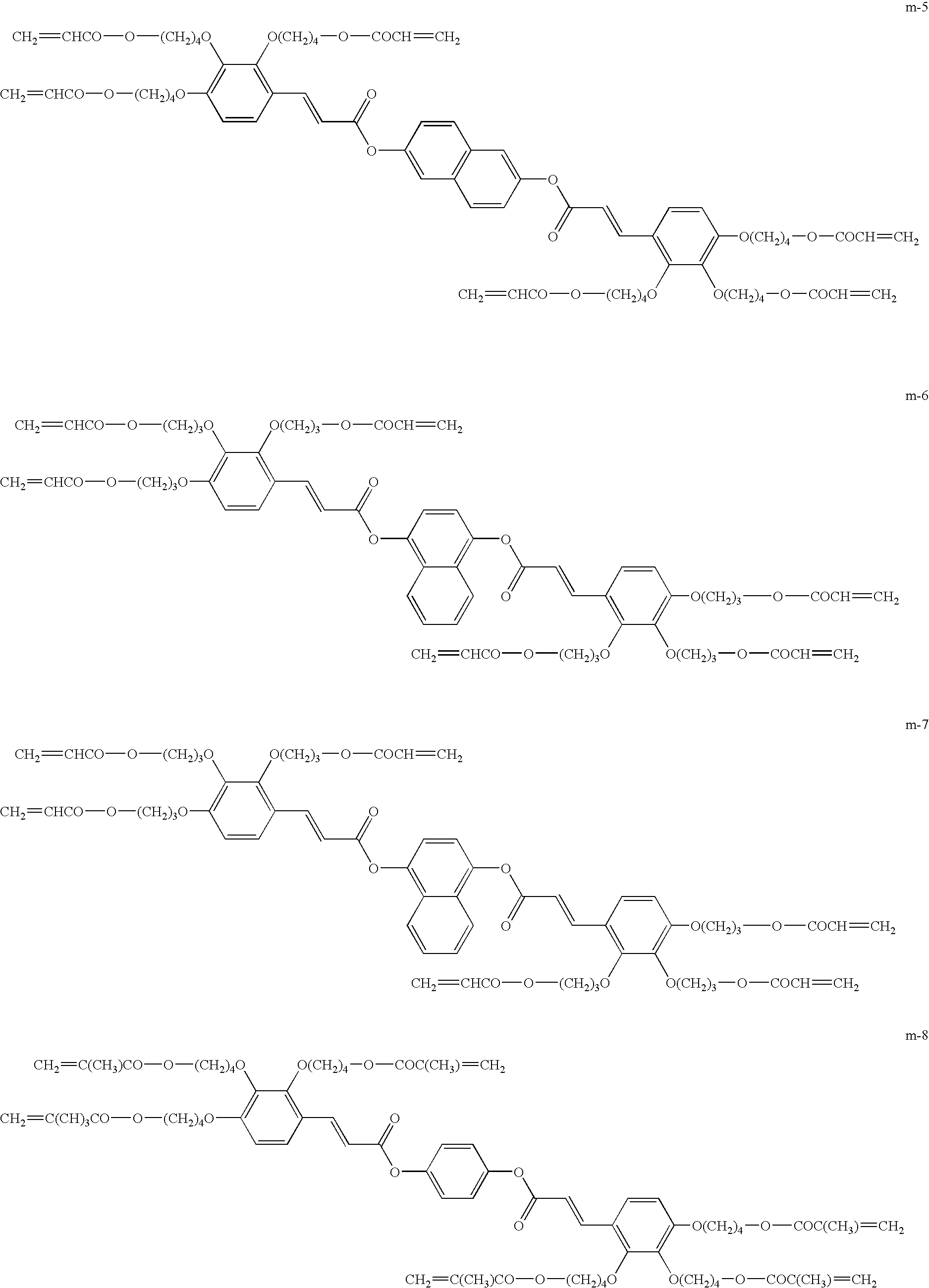

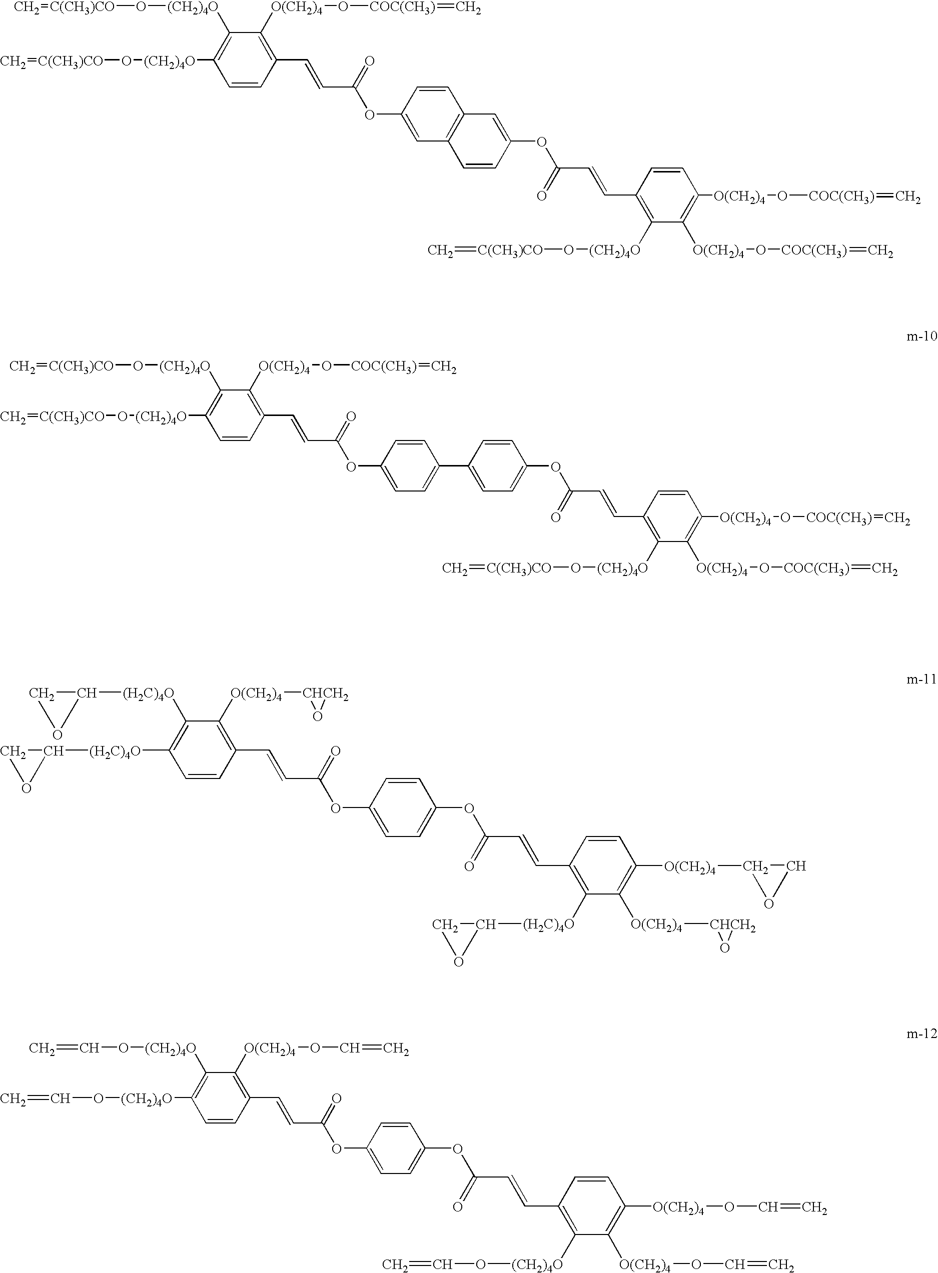

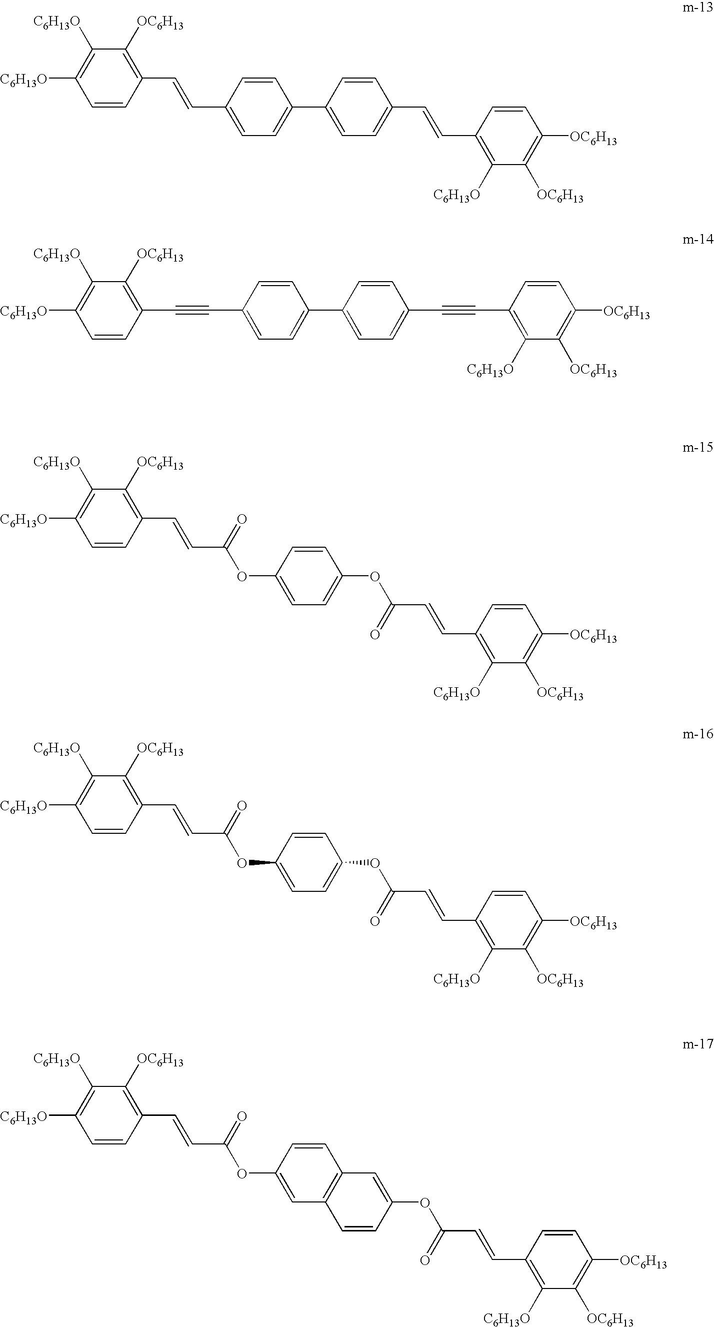

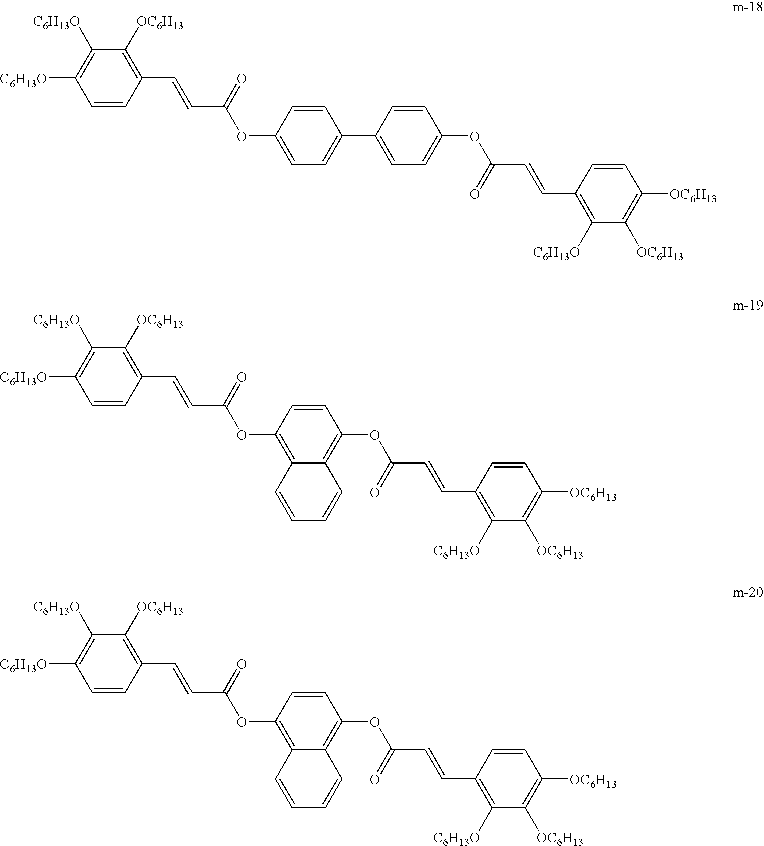

Specific examples of the polymer liquid crystal compound include the compounds described in H. F. Leube et al., Optical investigations on a liquid-crystalline side-chain polymer with biaxial nematic and biaxial smectic A phase; Makromol. Chem., Vol. 192, pp. 1317-1328 (1992) and New bilaterally linked mesogens in main-chain polymers with exhibition of biaxial fluctuation in nematic phase; Macromolecules, Vol. 31, pp. 3537-3541 (1998).

Other specific examples of the polymer liquid crystal compound which can be preferably used in the present invention are set forth below, however, the present invention is not limited thereto.

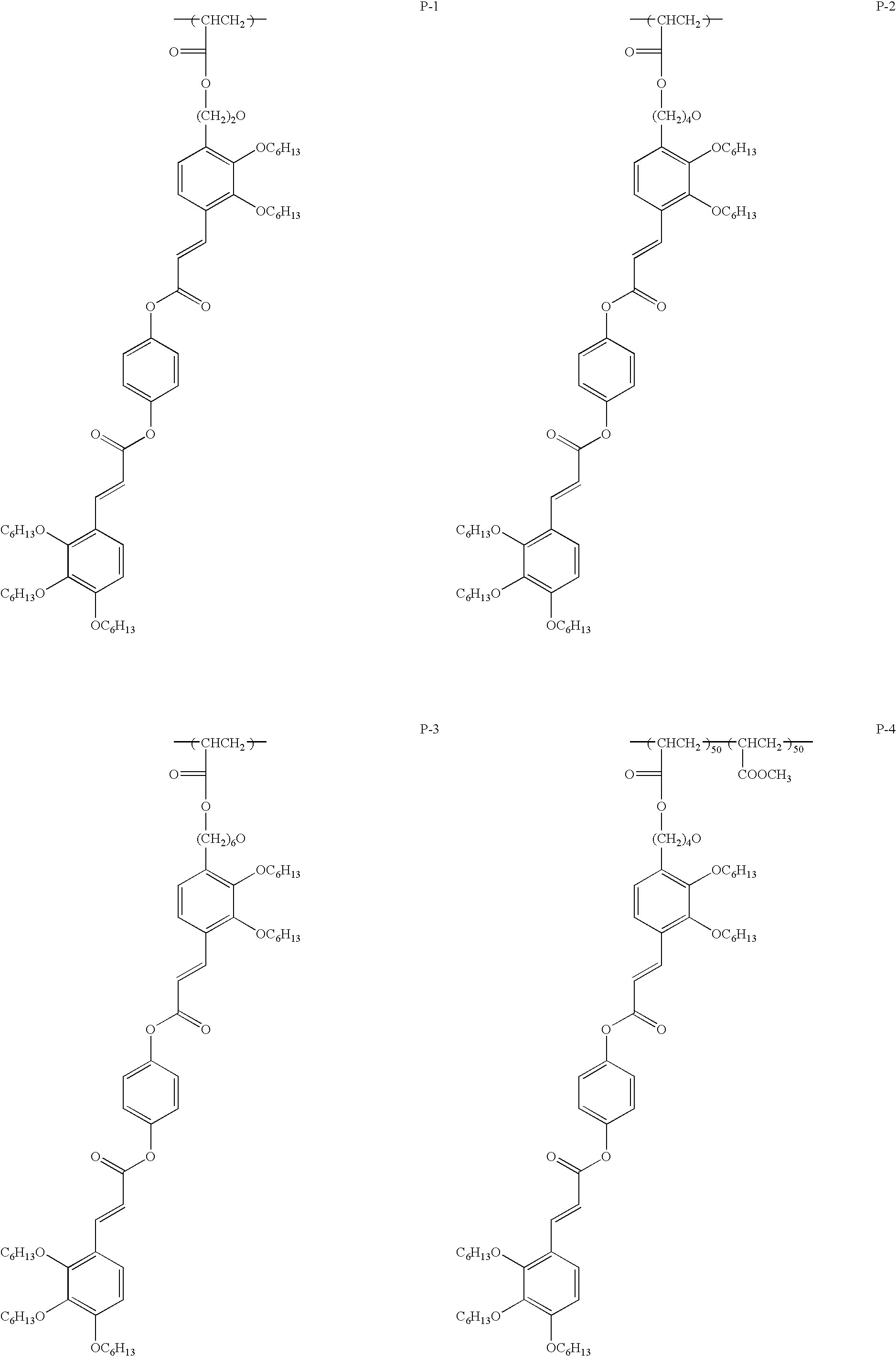

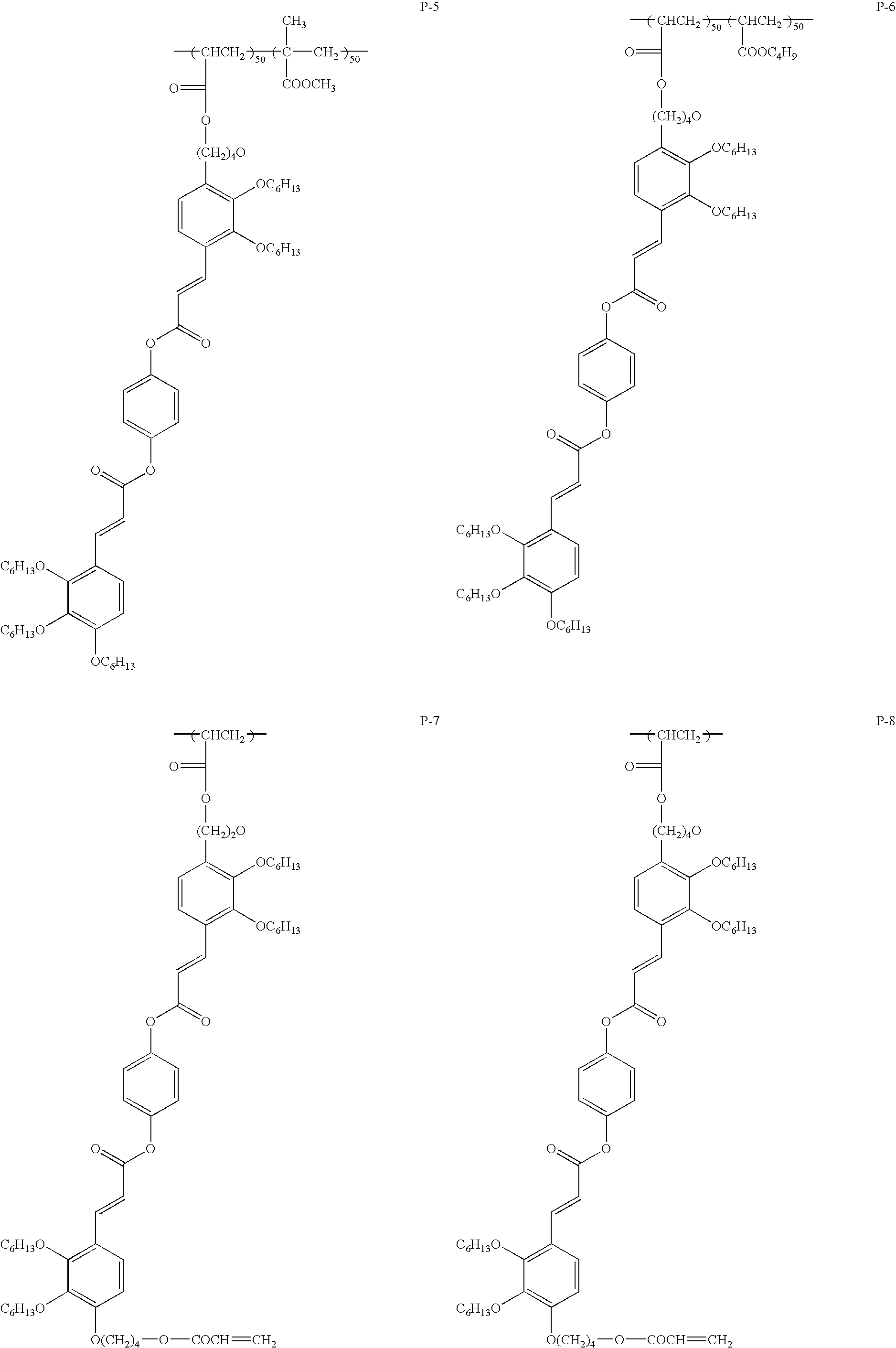

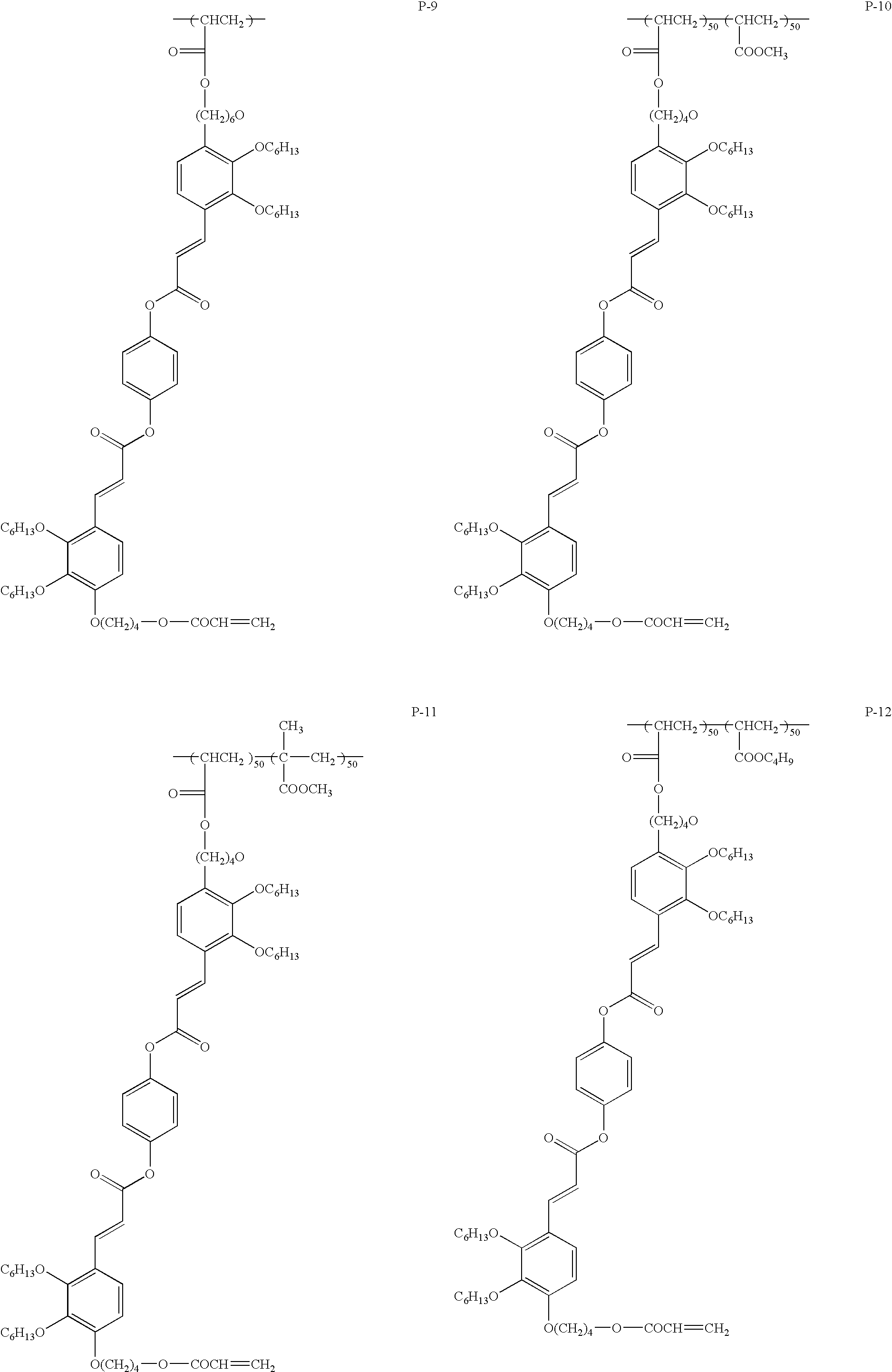

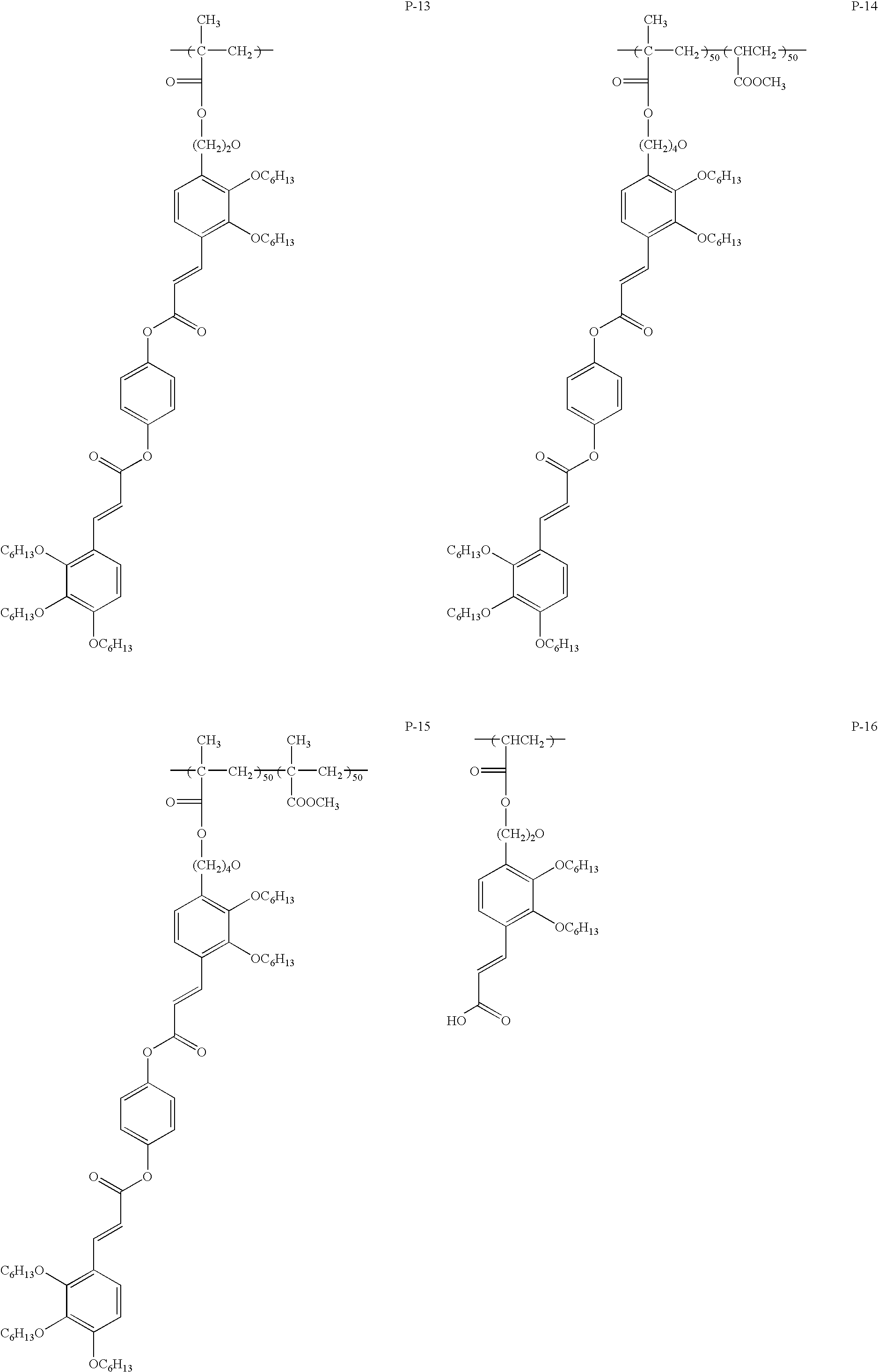

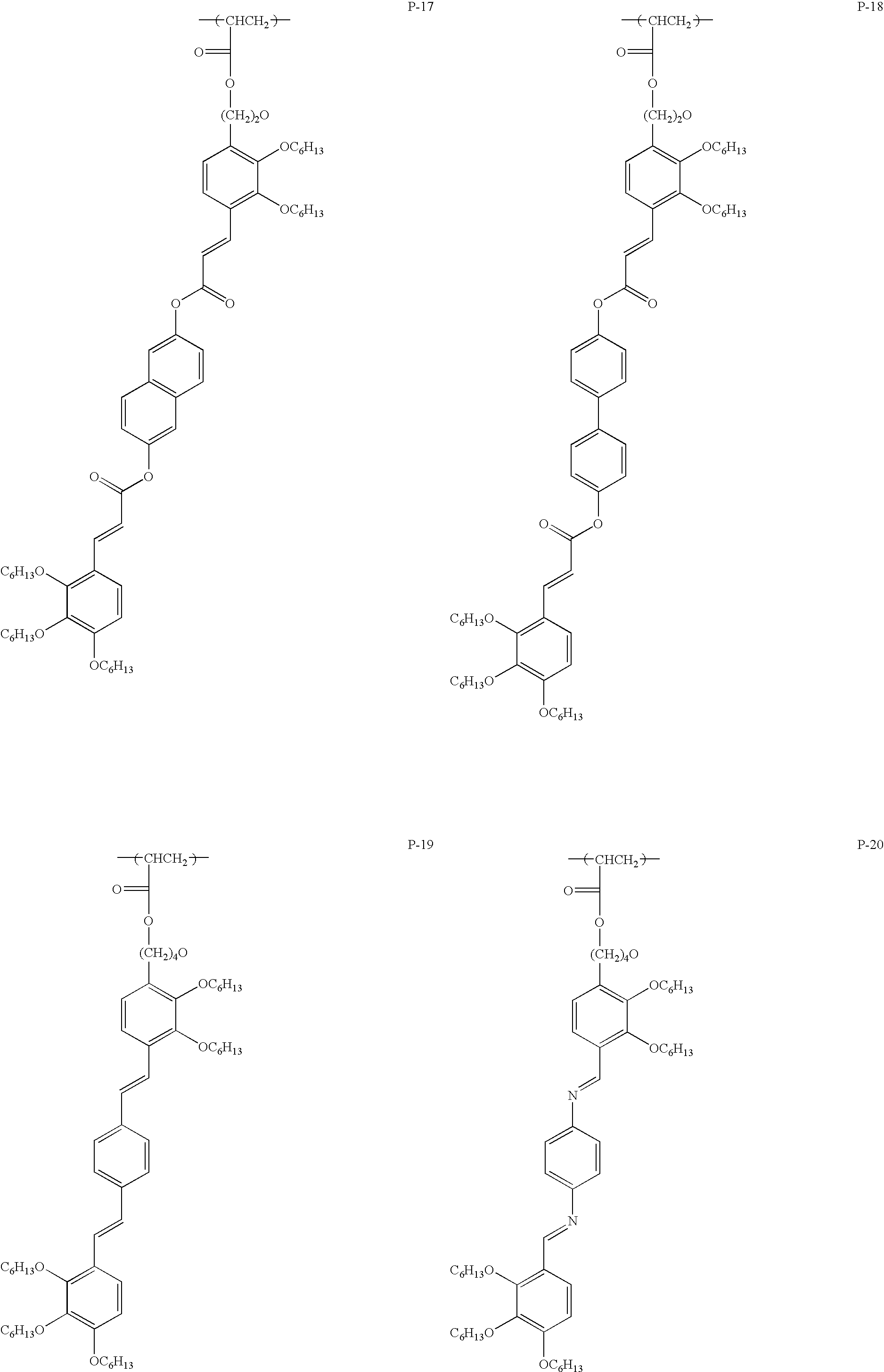

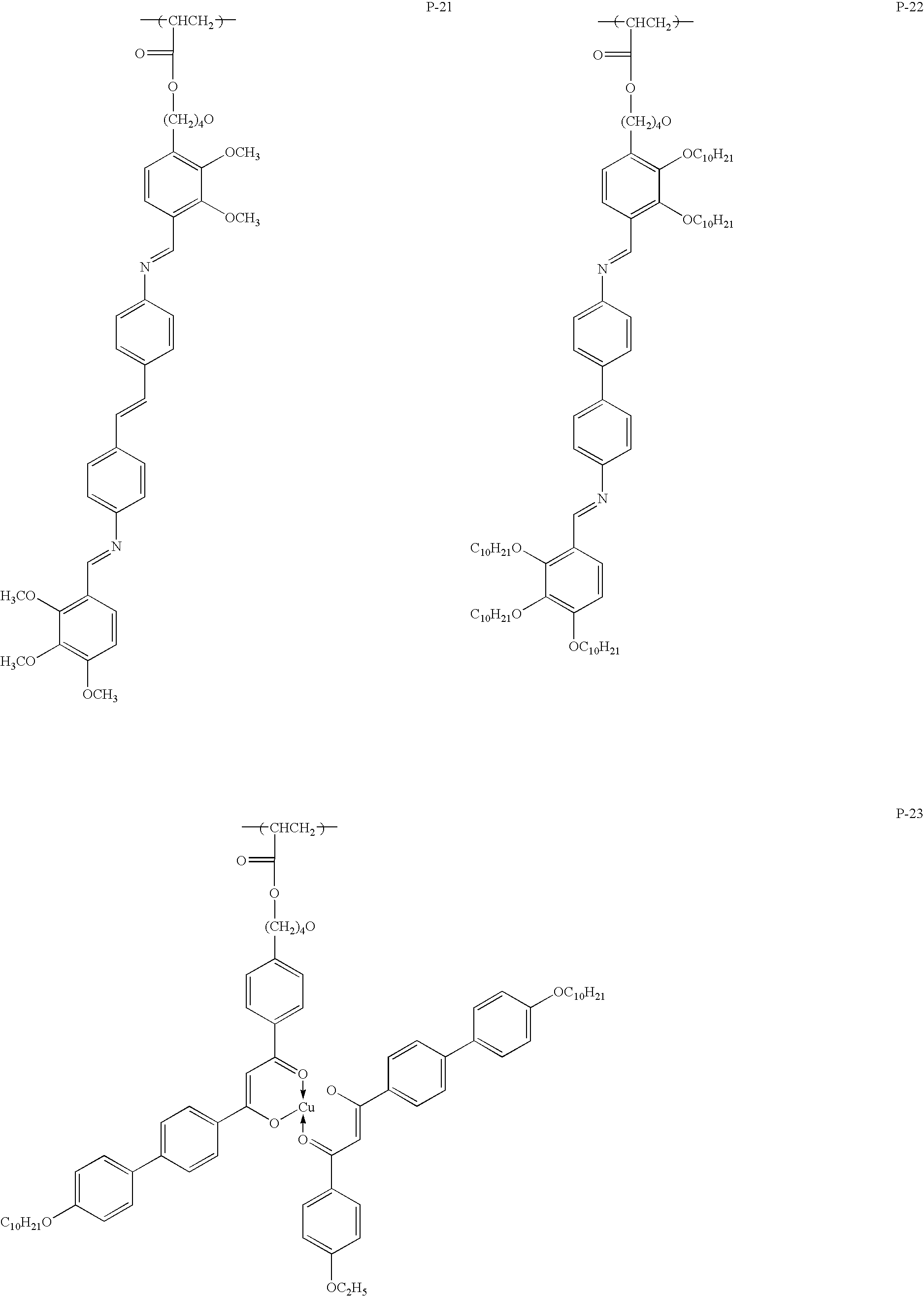

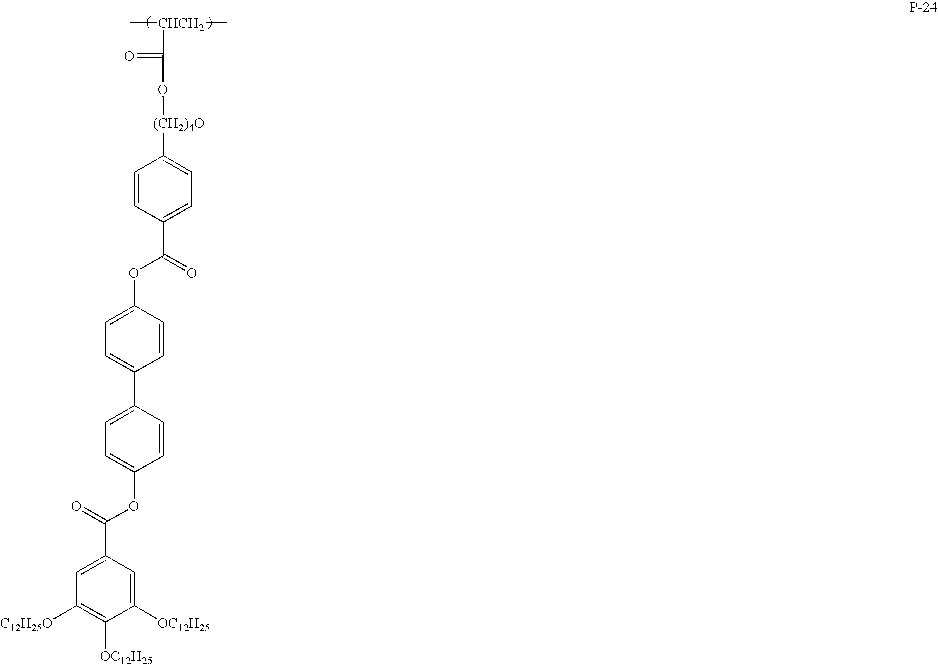

Liquid Crystal Composition:

In the present invention, the optically anisotropic layer contains at least one liquid crystal compound, and is formed of a liquid crystal composition expressing a biaxial liquid crystal phase as a composition.

From the aspect of suitability or the like for the production of a retardation film, the liquid crystal temperature of the liquid crystal composition is preferably from 10 to 200° C., more preferably from 10 to 150° C. If the liquid crystal temperature is less than 10° C., a cooling step or the like is sometimes required for lowering the temperature to the temperature range where the liquid crystal phase is expressed, whereas if it exceeds 200° C., a high temperature higher than the temperature range where a liquid crystal phase is once expressed is necessary for providing an isotropic liquid state and this is sometimes disadvantageous in view of waste of heat energy, deformation or deterioration of substrate, or the like.

Optically Anisotropic Layer:

In the present invention, the optical anisotropy of the optically anisotropic layer is controlled by using a liquid crystal compound to provide optical biaxiality such that principal refractive indexes in three directions orthogonal to each other are differing. The optically anisotropic layer may be substantially formed of a biaxial liquid crystal compound as the main component and may contain component(s) necessary for forming the layer (e.g., polymerization initiator). Assuming that principal refractive indexes in three directions of the optically anisotropic layer are nx, ny and nz (nx>ny>nz), respective values preferably satisfy the following equation (I), more preferably equation (II):

nx−ny>0.005 and ny−nz>0.005 Equation (I):

nx−ny>0.01 and ny−nz>0.01. Equation (II):

In the present invention, the liquid crystal compound is oriented (or aligned), for example, by using an alignment film described later to form an optically anisotropic layer with optical biaxiality. In the biaxial liquid crystal compound, unlike the uniaxial compound, principal refractive indexes (nx>ny>nz) in three directions orthogonal to each other are different and therefore, the orientation direction in these three directions must be controlled.

In the retardation film of the present invention, the direction (nz refractive index direction) having a minimum refractive index in the optically anisotropic layer and the normal direction of the transparent support (equivalent to the film thickness direction) are substantially orthogonal to each other. Furthermore, it is preferable that the direction having a maximum refractive index (nx refractive index direction) in the optically anisotropic layer and the normal direction of the transparent support are orthogonal to each other. Thus, it is aligned that the direction (nz refrective index direction) having minimum refractive index in the liquid crystal phase expressed by the liquid crystal composition and the normal direction of the transparent support (equivalent to the film thickness direction) are substantially orthogonal to each other. Furthermore, it is preferable that the direction (nx refractive index direction) having a maximum refractive index in the liquid crystal composition and the normal direction of the transparent support are substantially orthogonal to each other. The direction having a minimum refractive index (nz refractive index direction) may be parallel or orthogonal to the rubbing direction of the alignment film.

The liquid crystal composition of the present invention is coated over a support (preferably on an alignment film) and therefore, the liquid crystal compound is oriented at a pre-tilt angle of the support surface or coated-film interface (in the case where an alignment film is provided, it may be an alignment film interface) at the support-sided interface, and oriented at a pre-tilt angle of the air interface at the interface with air. In the case of a biaxial liquid crystal compound, the pre-tilt angle includes two kinds of pre-tilt angles, that is, a pre-tilt angle made by the nx refractive index direction and the interface and a pre-tilt angle made by the nz refractive index direction and the interface (the pre-tilt angle is based on the interface).

In the present invention, the term “the direction having a minimum refractive index in the optically anisotropic layer (nz refractive index direction) is substantially orthogonal to the normal direction of the transparent support (the normal direction in the film plane of the retardation film)” means that the angle between these two directions is from 75 to 105°, preferably from 80 to 100°, at both of the support-side interface and the air interface. In other words, in the case of using the biaxial liquid crystal compound, two pre-tilt angles between the nz refractive index direction of the liquid crystal compound and the support-side interface and between the nz refractive index direction and the interface with air both are from 0 to 15°, preferably from 0 to 10°.

Similarly, the term “the direction having a maximum refractive index in the optically anisotropic layer (nx refractive index direction) is substantially orthogonal to the normal direction of the transparent support (the normal direction in the film plane of the retardation film)” means that the angle between these two directions is from 75 to 105°, preferably from 80 to 100°, at both of the support-side interface and the air interface. In other words, in the case of the biaxial liquid crystal compound, two pre-tilt angles between the nx refractive index direction and the support-side interface and between the nx refractive index direction and the interface with air both are from 0 to 15°, preferably from 0 to 10°.

The orientation (angle formed) of the liquid crystal compound can be adjusted by the alignment film or its rubbing direction or further by an orientation controlling agent.

The biaxial film and the uniaxial film differ in the angle dependency of the retardation. For example, in the uniaxial film, the retardation in the normal direction of the film plane greatly differs from the retardation in the direction at an angle of tens of degrees from the normal line (the retardation becomes small when tilted toward the slow axis direction, and becomes large when tilted toward the fast axis direction). On the other hand, the biaxial film exhibits different variation from the uniaxial film. In the case of producing a retardation film for use in various liquid crystal display devices, the angle dependency of the retardation must be controlled in accordance with the liquid crystal display device and in this respect, the biaxial film is very useful, because the angle dependency of the retardation can be freely controlled by changing the difference in the refractive indexes nx, ny, and nz and changing the orientation direction of each axis. In this way, the biaxial film (retardation film) of the present invention where the angle between the refractive index direction and the normal direction of the film is controlled can serve as a retardation film less changing in the retardation whichever tilted toward the slow axis direction or toward the fast axis direction and therefore, this biaxial film is very useful for a liquid crystal display device requiring a retardation film having such optical property.

The optically anisotropic layer of the retardation film of the present invention is preferably formed by fixing the liquid crystal compound without impairing the orientation form in the liquid crystal state. In the case of using a polymer compound as the liquid crystal compound, the polymer compound is once heated to the liquid crystal phase forming temperature and then cooled while maintaining the oriented state, whereby the optically anisotropic layer can be obtained. In the case of using a polymerizable compound as the liquid crystal compound, the polymerizable compound is polymerized by heating it to the liquid crystal phase forming temperature and then cooled, whereby the optically anisotropic layer can be obtained.

The “fixed state” as used in the present invention means most typically and most preferably a state where the orientation of the liquid crystal phase is maintained, however, this state is not limited thereto and specifically indicates a state where the optically anisotropic layer does not exhibit fluidity at a temperature range usually from 0° C. to 50° C., in severer conditions, from −30° C. to 70° C., and also the fixed orientation form can be stably maintained without causing any change in the orientation form by external field or force.

In the present invention, when the optically anisotropic layer is finally formed, the liquid crystal compound may lose the liquid crystallinity as long as the biaxiality as a layer is maintained. For example, when a polymerizable compound is used as the liquid crystal compound, the polymerizable compound may come to have a high molecular weight and lose the liquid crystallinity as the polymerization or crosslinking reaction proceeds due to a reaction under heat, light or the like.

The optically anisotropic layer composed of a fixed liquid crystal composition where the alignment of the liquid crystal compound is fixed must have an appropriate hardness in view of suitability for the production of a retardation film. The hardness of the optically anisotropic layer can be determined by measuring the scratch strength of the surface. The scratch strength of the surface is preferably 10 g or more, more preferably 20 g or more. The scratch strength as used herein means a load (g) when the surface of the optically anisotropic layer is scratched by a sapphire needle having a conical apex angle of 90° and a tip diameter of 0.25 mm at a rate of 1 cm/sec and a scratch mark is observed with an eye.

In order to prevent the liquid crystal phase from undergoing orientation disorder at the air interface and having an orientation deprived of biaxiality, such as hybrid alignment, and also to prevent the shedding, the surface energy of the optically anisotropic layer is preferably 45 mN/m or less, more preferably from 20 to 43 mN/m.

The surface energy on the surface of the optically anisotropic layer can be decreased by an air interface orientation controlling agent or a shedding-preventing agent. The orientation controlling agent can be appropriately used according to the state of the liquid crystal phase to adjust the surface energy.

The surface energy of a solid can be determined by a contact angle method, a wetting heat method or an adsorption method as described in Nure no Kiso to Oyo (Elemental and Application of Wetting), Realize (Dec. 10, 1989). In the case of the optically anisotropic layer of the present invention, the contact angle method is preferably used. More specifically, a solution of water and diiodomethane, which surface energy is known, is dropped on the optically anisotropic layer and by defining that out of angles made by the tangent of liquid droplet and the optically anisotropic layer surface at the intersection of the liquid droplet surface and the optically anisotropic layer surface, the angle including the liquid droplet is the contact angle, the surface energy of the optically anisotropic layer can be calculated by computation.

The thickness of the optically anisotropic layer formed of a biaxial liquid crystal composition is preferably from 0.1 to 20 μm, more preferably from 0.2 to 15 μm, and most preferably from 0.5 to 10 μm.

Additive of Optically Anisotropic Layer:

In the liquid crystal composition used for forming the optically anisotropic layer of the present invention, arbitrary additives may be used in addition to the compound of expressing a liquid crystal phase as described above. Examples of the additive include an air interface orientation controlling agent, a shedding-preventing agent, a polymerization initiator and a polymerizable monomer.

Air Interface Orientation Controlling Agent:

For controlling the pre-tilt angle at the air interface, an additive is preferably used. In the present invention, this additive is preferably a compound containing within the molecule one or more, more preferably two or more, substituted or unsubstituted aliphatic group(s) having from 6 to 40 carbon atoms, or substituted or unsubstituted aliphatic-substituted oligosiloxanoxy group(s) having from 6 to 40 carbon atoms. For example, the hydrophobic compounds having exclude-volume effect described in JP-A-2002-20363 can be used as the air interface orientation controlling agent.

The amount added of the additive for controlling the orientation in the air interface side is preferably from 0.001 to 20 mass %, more preferably from 0.01 to 10 mass %, and most preferably from 0.1 to 5 mass %, based on the liquid crystal compound.

Shedding-Preventing Agent:

In general, as the material used together with the liquid crystal compound to prevent the shedding at the coating of the liquid crystal composition, a polymer can be suitably used.

The polymer used is not particularly limited insofar as it does not extremely change the tilt angle or inhibit the orientation of the liquid crystal compound.

Examples of the polymer include those described in JP-A-8-95030 and specific examples of particularly preferred polymers include cellulose esters. Examples of the cellulose ester include cellulose acetate, cellulose acetate propionate, hydroxypropylcellulose and cellulose acetate butyrate.

In order not to inhibit the orientation of the liquid crystal compound, the amount added of the polymer used for preventing the shedding is generally from 0.1 to 10 mass %, preferably from 0.1 to 8 mass %, more preferably from 0.1 to 5 mass %, based on the liquid crystalline compound.

Polymerization Initiator:

In the present invention, the liquid crystal compound is preferably fixed in the monodomain alignment, namely, in the substantially uniformly oriented state. For this purpose, when a polymerizable liquid crystal compound is used, the liquid crystal compound is preferably fixed by polymerization reaction.

The polymerization reaction includes a thermal polymerization reaction using a thermal polymerization initiator, a photopolymerization reaction using a photopolymerization initiator, and a polymerization reaction by the irradiation of an electron beam. A photopolymerization reaction and a polymerization reaction by the irradiation of an electron beam are preferred so as to prevent the support or the like from deformation or deterioration due to heat.

Examples of the photopolymerization initiator include α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combinations of triarylimidazole dimer and p-aminophenyl ketone (described in U.S. Pat. No. 3,549,367), acridine and phenazine compounds (described in JP-A-60-105667 and U.S. Pat. No. 4,239,850) and oxadiazole compounds (described in U.S. Pat. No. 4,212,970).

The amount of the photopolymerization initiator used is preferably from 0.01 to 20 mass %, more preferably from 0.5 to 5 mass %, based on the solid content of the liquid crystal composition.

The light irradiation for the polymerization of the liquid crystalline molecule is preferably performed by using an ultraviolet ray. The irradiation energy is preferably from 10 mJ/m² to 50 J/cm², more preferably from 50 to 800 mJ/cm². In order to accelerate the photo-polymerization reaction, the light irradiation may be performed under heating. The oxygen concentration in the atmosphere contributes to the polymerization degree and therefore, when a predetermined polymerization degree is not achieved in air, the oxygen concentration is preferably decreased by nitrogen purging or the like. The oxygen concentration is preferably 10% or less, more preferably 7% or less, and most preferably 3% or less.

Polymerizable Monomer:

In the liquid crystal composition, a polymerizable monomer may be added. The polymerizable monomer which can be used is not particularly limited insofar as it has compatibility with the liquid crystal compound and does not extremely change the tilt angle or inhibit the orientation of the liquid crystal compound. Among these polymerizable monomers, compounds having a polymerization-active ethylenic unsaturated group such as vinyl group, vinyloxy group, acryloyl group and methacryloyl group are preferred. The amount of the polymerizable monomer added is generally from 0.5 to 50 mass %, preferably from 1 to 30 mass %, based on the liquid crystal compound. When a monomer having two or more reactive functional groups is used, an effect of enhancing the adhesion between the alignment film and the optically anisotropic layer may be provided and therefore, this is particularly preferred.

Coating Solvent:

The solvent used for the preparation of the liquid crystal composition is preferably an organic solvent. Examples of the organic solvent include amides (e.g., N,N-dimethylformamide), sulfoxides (e.g., dimethylsulfoxide), heterocyclic compounds (e.g., pyridine), hydrocarbons (e.g., toluene, hexane), alkyl halides (e.g., chloroform, dichloromethane), esters (e.g., methyl acetate, butyl acetate), ketones (e.g., acetone, methyl ethyl ketone, methyl isobutyl ketone, cyclohexanone) and ethers (e.g., tetrahydrofuran, 1,2-dimethoxyethane). Among these, alkyl halides, esters and ketones are preferred. Two or more organic solvents may be used in combination.

Coating Method:

The optically anisotropic layer is formed by preparing a coating solution of the biaxial liquid crystal composition by using the above-described solvent and then coating the solution on an alignment film to orient the biaxial liquid crystal compound. The coating solution can be coated by a known method (e.g., wire bar coating, extrusion coating, direct gravure coating, reverse gravure coating, die coating).

Alignment Film:

The alignment film can be provided, for example, by rubbing of an organic compound (preferably a polymer), oblique vapor deposition of an inorganic compound, formation of a layer having microgrooves, or accumulation of an organic compound (e.g., ω-tricosanoic acid, methyl stearate) according to a Langmuir-Blodgett (LB film) method. Also, an alignment film capable of exerting an aligning function upon application of an electric or magnetic field or irradiation with light is known.

The alignment film may be any layer as long as the liquid crystal compound of the optically anisotropic layer provided on the alignment film can be oriented in desired alignment, however, in the present invention, the alignment film is preferably formed by rubbing treatment or irradiation with light. In particular, an alignment film formed by rubbing a polymer is preferred. The rubbing treatment can be generally performed by rubbing the surface of the polymer layer with paper or cloth several times along a certain direction, however, in the present invention, this treatment is preferably performed by the method described in Ekisho Binran (Handbook of Liquid Crystal), Maruzen.

The thickness of the alignment film is preferably from 0.01 to 10 μm, more preferably from 0.05 to 3 μm.

In the present invention, a polymer having a hydrophobic group or an exclude-volume group is preferably used for the alignment film.

The hydrophobic group as used herein means a hydrocarbon group having from 10 to 100 carbon atoms or a fluorine atom-substituted hydrocarbon group having from 1 to 100 carbon atoms. The hydrocarbon group is an aliphatic group, an aromatic group or a combination thereof. The aliphatic group may be cyclic, branched or linear. The aliphatic group is preferably an alkyl group (which may be a cycloalkyl group) or an alkenyl group (which may be a cycloalkenyl group). The hydrocarbon group may have a substituent which does not exhibit strong hydrophilicity, such as halogen atom. The number of carbon atoms in the hydrocarbon group is preferably from 10 to 80, more preferably from 10 to 60, and most preferably from 10 to 40.

The hydrocarbon group preferably has a steroid structure. The steroid structure has an exclude-volume effect in addition to a function of decreasing the surface energy of the alignment film. When the extruded volume effect is imparted to the alignment film, a state where liquid crystal molecules are erected is provided synergistically with the surface energy decreasing effect. In the present invention, the steroid group means a cyclopentanohydrophenanthrene ring group or a ring group where the bonds of the cyclopentanohydrophenanthrene ring group are partially replaced by a double bond. The number of carbon atoms in the hydrocarbon group having a steroid group is preferably from 18 to 100, more preferably from 19 to 60, and most preferably from 20 to 40. It is also preferred that the hydrocarbon group contains at least two aromatic or aromaheterocyclic rings.

The hydrocarbon group of the fluorine atom-substituted hydrocarbon group is an aliphatic group, an aromatic group or a combination thereof. The aliphatic group may be cyclic, branched or linear. The aliphatic group is preferably an alkyl group (which may be a cycloalkyl group) or an alkenyl group (which may be a cycloalkenyl group). The aliphatic group may have, in addition to the fluorine atom, a substituent which does not exhibit strong hydrophilicity, such as other halogen atoms. The number of carbon atoms in the fluorine atom-substituted hydrocarbon group is preferably from 5 to 80, more preferably from 10 to 60, and most preferably from 10 to 40. The hydrogen atom of the hydrocarbon group is preferably replaced by the fluorine atom in a percentage of 50 to 100 mol %, more preferably from 70 to 100 mol %, still more preferably from 80 to 100 mol %, and most preferably from 90 to 100 mol %.

The polymer having a hydrophobic group is preferably used for the alignment film of the present invention because of the following reasons.

Use of the hydrophobic group is considered to cause reduction in the surface tension of the alignment film and thereby facilitate the realization of the orientation state of the present invention in the optically anisotropic layer. It is reported that when the surface tension of the alignment film is decreased, normal rod-like liquid crystals readily stand at the interface with the alignment film (see, for example, Ekisho Binran (Handbook of Liquid Crystal), compiled by Ekisho Binran Henshu Iinkai, p. 231, Maruzen (2000)). This is considered to result because when, for example, an alkyl group is used as the hydrophobic group, the direction having many occurrences of interaction between the alkyl group of the rod-like liquid crystal and the alkyl group of the alignment film, namely, the direction where the molecules stand, becomes to have an advantage.

Examples of the exclude-volume group include groups which are an aliphatic ring group, an aromatic group or a heterocyclic group and have an exclude-volume effect. The aliphatic ring of the aliphatic ring group is preferably a 5-, 6- or 7-membered ring, more preferably a 5- or 6-membered ring, and most preferably a 6-membered ring. Examples of the aliphatic ring include a cyclohexane ring, a cyclohexene ring and a bicyclo[2.2.1]hept-2-ene ring. The aliphatic ring may be condensed with another aliphatic ring, an aromatic ring or a heterocyclic ring. Examples of the aromatic ring of the aromatic group include a benzene ring, a naphthalene ring, an anthracene ring, a phenanthrene ring, a pyrene ring and a naphthacene ring. The aromatic ring may be condensed with an aliphatic ring or a heterocyclic ring. The heterocyclic ring of the heterocyclic group is preferably a 5-, 6- or 7-membered ring, more preferably a 5- or 6-membered ring. The heterocyclic ring preferably has aromaticity. The aromaheterocyclic ring is generally unsaturated and preferably has a largest number of double bonds. Examples of the heterocyclic ring include a furan ring, a thiophene ring, a pyrrole ring, an oxazole ring, an isoxazole ring, an isothiazole ring, an imidazole ring, a pyrazole ring, a furazane ring, a pyridine ring, a pyridazine ring, a pyrimidine ring and a pyrazine ring. The heterocyclic ring may be condensed with another heterocyclic ring, an aliphatic ring or an aromatic ring.

The aliphatic ring group, the aromatic group and the heterocyclic group each may have a substituent. Examples of the substituent include an alkyl group (e.g., methyl, ethyl, tert-butyl), a substituted alkyl group (e.g., chloromethyl, hydroxymethyl, trimethylammonio chloride), an alkoxy group (e.g., methoxy), a halogen atom (e.g., F, Cl, Br), a carboxyl group, an acyl group (e.g., formyl), an amino group, a sulfo group, an aryl group (e.g., phenyl), an aryloxy group (e.g., phenoxy) and an oxo.

The polymer having an exclude-volume group is preferably used for the alignment film of the present invention because of the following reasons.

Use of the exclude-volume group facilitates the realization of the orientation state of the present invention in the optically anisotropic layer. One of the reasons why liquid crystal molecules are aligned in a certain direction is an exclude-volume effect (see, for example, Ekisho Binran (Handbook of Liquid Crystal), compiled by Ekisho Binran Henshu Iinkai, page 47, Maruzen (2000)). The exclude-volume effect is an effect of most densely filling molecules within a fixed volume. For example, rod-like molecules can be most densely filled by aligning the adjacent molecule to lie along the rod. It is presumed that in the case of using this rod-like molecule for the alignment film, when the rod (exclude-volume group) is made to protrude from the alignment film surface, other molecules are aligned to lie along the rod and by controlling the protruded state or the shape of the protruded rod, the orientation state of the present invention can be readily realized in the optically anisotropic layer.

In the present invention, the polymer for use in the alignment film is preferably water-soluble. The water-soluble polymer as used herein means a polymer which dissolves to a concentration of 0.1 mass % or more in an aqueous solvent containing 50 mass % or more of water (examples of the water-soluble solvent which can be added to water include an alcohol-base solvent (e.g., methanol, ethanol, isopropanol), an ether-base solvent (e.g., tetrahydrofuran), a ketone-base solvent (e.g., acetone), a nitrile-base solvent (e.g., acetonitrile) and an amide-base solvent (e.g., dimethylformamide, dimethylacetamide). A polymer which dissolves to a concentration of 1 mass % or more is preferred.

Preferred examples of the substituent which imparts water solubility to the polymer include a substituent of reacting with an organic or inorganic base to form a salt, such as carboxyl group and sulfo group, a salt formed by the substituent, a substituent of reacting with an organic or inorganic acid to form a salt, such as primary amino group, secondary amino group and tertiary amino group, a salt formed by the substituent, a substituent of forming a hydrogen bond with water, such as hydroxy group, mercapto group and ether group, and a substituent in the form of a salt, such as quaternary amino group. Among these, a substituent of reacting with an organic or inorganic base to form a salt, such as carboxy group and sulfo group, and a salt formed by the substituent are preferred.

In the present invention, the polymer used for the alignment film is preferably an acrylic or methacrylic acid copolymer containing a repeating unit represented by the following formula (I) and a repeating unit represented by the following formula (II) or (III):

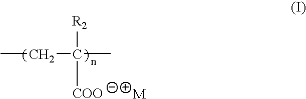

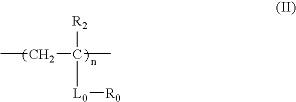

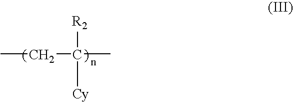

wherein R₁ represents a hydrogen atom or a methyl group, R₂ represents a hydrogen atom, a halogen atom or an alkyl group having from 1 to 6 carbon atoms, M represents a proton, an alkali metal ion or an ammonium ion, L₀ represents a divalent linking group selected from the group consisting of —O—, —CO—, —NH—, —SO₂—, an alkylene group, an alkenylene group, an arylene group and a combination thereof, R₀ represents a hydrocarbon group having from 10 to 100 carbon atoms or a fluorine atom-substituted hydrocarbon group having from 1 to 100 carbon atoms, C_{y} represents an aliphatic ring group, an aromatic group or a heterocyclic group, m is from 10 to 99 mol %, and n is from 1 to 90 mol %.

As the above-described acrylic or methacrylic acid copolymer, the compounds described in JP-A-2002-98828 may also be used.

Rubbing Density of Alignment Film:

The rubbing density of the alignment film and the pre-tilt angle of the liquid crystal compound at the interface with the alignment film have a relationship such that as the rubbing density is increased, the pre-tilt angle becomes small, whereas as the rubbing density is decreased, the pre-tilt angle becomes large. Therefore, the pre-tilt angle can be adjusted by varying the rubbing density of the alignment film.

The rubbing density of the alignment film can be varied by the method described in Ekisho Binran (Handbook of Liquid Crystal), complied by Ekisho Binran Henshu Iinkai, Maruzen (2000). The rubbing density (L) is quantified by formula (A):

L=Nl(1+2πrn/60v) Formula (A):

wherein N is the number of rubbings, l is the contact length of the rubbing roller, r is the radius of the roller, n is the rotation number (rpm) of the roller and v is the stage moving speed (per second).

The rubbing density may be elevated by increasing the number of rubbings, the contact length of the rubbing roller, the radius of the roller or the rotation number of the roller or decreasing the stage moving speed. On the other hand, the rubbing density may be lowered by reversing the increase or decrease of these factors.

Transparent Support:

With respect to the transparent support for use in the retardation film of the present invention, the material therefor is not particularly limited as long as it mainly exhibits optical isotropy and ensures a light transmittance of 80% or more, however, a polymer film is preferably used.

Specific examples of the polymer include cellulose esters (e.g., cellulose diacetate, cellulose triacetate), norbornene-base polymers, and poly(meth)acrylate esters. Many commercially available polymers can be suitably used. Among these, in view of the optical performance, cellulose esters are preferred and lower fatty acid esters of cellulose are more preferred. The lower fatty acid means a fatty acid having 6 or less carbon atoms and the number of carbon atoms is preferably 2 (cellulose acetate), 3 (cellulose propionate) or 4 (cellulose butyrate). Of these, cellulose triacetate is more preferred. A mixed fatty acid ester such as cellulose acetate propionate and cellulose acetate butyrate may also be used. Furthermore, even in the case of conventionally known polymers of readily expressing birefringence, such as polycarbonate and polysulfone, those reduced in the expression by modifying the molecule, described in WO00/26705, can be used.

The cellulose ester (particularly cellulose) which is preferably used as the transparent support is described in detail below.

The cellulose ester is preferably a cellulose acetate having an acetylation degree of 55.0 to 62.5%, more preferably from 57.0 to 62.0%. The acetylation degree means the amount of acetic acid bonded per the unit mass of cellulose. The acetylation degree is determined according to the Measurement and Calculation of Acetylation Degree described in ASTM D-817-91 (Test Method of Cellulose Acetate, etc.).

The viscosity average polymerization degree (DP) of cellulose ester is preferably 250 or more, more preferably 290 or more. The cellulose ester for use in the present invention preferably has a narrow molecular weight distribution Mw/Mn (Mw is a mass average molecular weight and Mn is a number average molecular weight) as measured by gel permeation chromatography. Specifically, the Mw/Mn value is preferably from 1.0 to 1.7, more preferably from 1.3 to 1.65, and most preferably from 1.4 to 1.6.

In the cellulose ester, the hydroxyl groups at the 2-position, 3-position and 6-position of cellulose are not evenly distributed in ⅓ portions of the entire substitution degree but the substitution degree of hydroxyl group at the 6-position is liable to become small. The substitution degree of hydroxyl group at the 6-position of cellulose is preferably larger than those at the 2-position and 3-position. The hydroxyl group at the 6-position is preferably substituted by an acyl group to account for 30 to 40%, preferably 31% or more, more preferably 32% or more, of the entire substitution degree. The substitution degree at the 6-position is preferably 0.88 or more. The hydroxyl group at the 6-position may be substituted by an acyl group having 3 or more carbon atoms (e.g., propionyl, butyryl, valeroyl, benzoyl, acryloyl) other than an acetyl group. The substitution degree at each position can be determined by NMR. Cellulose esters having a high substitution degree of hydroxyl group at the 6-position can be synthesized by referring to the methods described in JP-A-11-5851, that is, Synthesis Example 1 (paragraphs 0043 to 0044), Synthesis Example 2 (paragraphs 0048 to 0049) and Synthesis Example 3 (paragraphs 0051 to 0052).

In the polymer film used as the transparent support, particularly in the cellulose acetate film, an aromatic compound having at least two aromatic rings may be used as a retardation increasing agent so as to adjust the retardation. In the case of using such a retardation increasing agent, the retardation increasing agent is used in an amount of 0.01 to 20 parts by mass, preferably from 0.05 to 15 parts by mass, more preferably from 0.1 to 10 parts by mass, per 100 parts by mass of the cellulose acetate. Two or more aromatic compounds may be used in combination.

The aromatic ring of the aromatic compound includes an aromatic hydrocarbon ring and an aromaheterocyclic ring.

The aromatic hydrocarbon ring is preferably a 6-membered ring (namely, benzene ring).

The aromaheterocyclic ring is generally an unsaturated heterocyclic ring. The aromaheterocyclic ring is preferably a 5-, 6- or 7-membered ring, more preferably a 5- or 6-membered ring. The aromaheterocyclic ring generally has a largest number of double bonds. The heteroatom is preferably a nitrogen atom, an oxygen atom or a sulfur atom, more preferably a nitrogen atom. Examples of the aromaheterocyclic ring include a furan ring, a thiophene ring, a pyrrole ring, an oxazole ring, an isoxazole ring, a thiazole ring, an isothiazole ring, an imidazole ring, a pyrazole ring, a furazane ring, a triazole ring, a pyrane ring, a pyridine ring, a pyridazine ring, a pyrimidine ring, a pyrazine ring and a 1,3,5-triazine ring.

The aromatic ring is preferably a benzene ring, a furan ring, a thiophene ring, a pyrrole ring, an oxazole ring, a thiazole ring, an imidazole ring, a triazole ring, a pyridine ring, a pyrimidine ring, a pyrazine ring or a 1,3,5-triazine ring, more preferably a benzene ring or a 1,3,5-triazine ring. The aromatic compound preferably contains at least one 1,3,5-triazine ring.

The number of aromatic rings in the aromatic compound is preferably from 2 to 20, more preferably from 2 to 12, still more preferably from 2 to 8, and most preferably from 2 to 6.

The bonding relationship of two aromatic rings can be classified into (a) a case where two aromatic rings are bonded to form a condensed ring, (b) a case where two aromatic rings are directly bonded by a single bond and (c) a case where two aromatic rings are bonded through a linking group (a spiro bond cannot be formed because the rings are an aromatic ring). The bonding relationship may be any one of (a) to (c). Such a retardation increasing agent is described in WO01/88574A1, WO00/2619A1, JP-A-2000-111914, JP-A-2000-275434 and Japanese Patent Application No. 2002-70009.

The cellulose acetate film is preferably produced by preparing a cellulose acetate solution (dope) and forming a film from the solution according to a solvent casting method. In the dope, the above-described retardation increasing agent may be added.

The dope is cast on a drum or a band and the solvent is evaporated to form a film. The concentration of the dope before casting is preferably adjusted to give a solid content of 18 to 35%. The surface of the drum or band is preferably finished to provide a mirror state. The casting and drying methods in the solvent casting method are described in U.S. Pat. Nos. 2,336,310, 2,367,603, 2,492,078, 2,492,977, 2,492,978, 2,607,704, 2,739,069 and 2,739,070, British Patents 640,731 and 736,892, JP-B-45-4554 (the term “JP-B” as used herein means an “examined Japanese patent publication”), JP-B-49-5614, JP-A-60-176834, JP-A-60-203430 and JP-A-62-115035.

The dope is preferably cast on a drum or band having a surface temperature of 10° C. or less. After the casting, the dope is preferably dried with air for 2 seconds or more. The obtained film is peeled off from the drum or band and the film may be further dried with hot air by sequentially varying the temperature from 100° C. to 160° C. to remove the residual solvent. This method is described in JP-B-5-17844. According to this method, the time from casting until peeling can be shortened. For practicing this method, it is necessary that the dope is gelled at the surface temperature of the drum or band on casting.

Using the prepared cellulose acetate solution (dope), dopes of two or more layers may also be cast to form a film. The dopes are cast on a drum or a band and the solvent is evaporated to form a film. The concentration of each dope before casting is preferably adjusted to give a solid content of 10 to 40%. The surface of the drum or band is preferably finished to provide a mirror state.

In the case of casting a plurality of cellulose acetate solutions, a film may be produced by casting respective cellulose acetate-containing solutions from a plurality of casting ports provided with spacing in the traveling direction of the support and thereby stacking the layers. For example, the methods described in JP-A-61-158414, JP-A-1-122419 and JP-A-11-198285 can be used. Furthermore, a film may be produced by casting cellulose acetate solutions from two casting ports and for example, the methods described in JP-B-60-27562, JP-A-61-94724, JP-A-61-947245, JP-A-61-104813, JP-A-61-158413 and JP-A-6-134933 can be used. In addition, the method for casting cellulose acetate film described in JP-A-56-162617 may also be used, where a flow of a high-viscosity cellulose acetate solution is wrapped with a low-viscosity cellulose acetate solution and the high-viscosity and low-viscosity cellulose acetate solutions are simultaneously extruded.

The cellulose acetate film may be further subjected to a stretching treatment to adjust the retardation. The stretching magnification is preferably from 0 to 100%. In the case of stretching the cellulose acetate film for use in the present invention, tenter stretching is preferably used and in order to highly precisely control the slow axis, the difference, for example, in the speed between right and left tenter clips or in the timing of disengagement is preferably reduced as small as possible.

In the cellulose ester film, a plasticizer may be added so as to improve the mechanical properties or increase the drying speed. As the plasticizer, a phosphoric acid ester or a carboxylic acid ester is used. Examples of the phosphoric acid ester include triphenyl phosphate (TPP) and tricresyl phosphate (TCP). The carboxylic acid ester is represented by a phthalic acid ester and a citric acid ester. Examples of the phthalic acid ester include dimethyl phthalate (DMP), diethyl phthalate (DEP), dibutyl phthalate (DBP), dioctyl phthalate (DOP), diphenyl phthalate (DPP) and di-2-ethylhexyl phthalate (DEHP). Examples of the citric acid ester include triethyl O-acetylcitrate (OACTE) and tributyl O-acetylcitrate (OACTB). Other examples of the carboxylic acid ester include butyl oleate, methylacetyl ricinoleate, dibutyl sebacate and various trimellitic acid esters. Among these, phthalic acid ester-base plasticizers (DMP, DEP, DBP, DOP, DPP, DEHP) are preferred, and DEP and DPP are more preferred. The amount of the plasticizer added is preferably from 0.1 to 25 mass %, more preferably from 1 to 20 mass %, and most preferably 3 to 15 mass %, based on the amount of the cellulose ester.

In the cellulose ester film, a deterioration inhibitor (e.g., antioxidant, peroxide decomposer radical inhibitor, metal inactivating agent, oxygen scavenger, amine) or an ultraviolet inhibitor may be added. The deterioration inhibitor is described in JP-A-3-199201, JP-A-5-197073, JP-A-5-194789, JP-A-5-271471 and JP-A-6-107854. The amount of the deterioration inhibitor added is preferably from 0.01 to 1 mass %, more preferably from 0.01 to 0.2 mass %, based on the solution (dope) prepared. If the amount added is less than 0.01 mass %, the effect of deterioration inhibitor can be hardly obtained, whereas if it exceeds 1 mass %, the deterioration inhibitor sometimes bleeds out onto the film surface.

Examples of particularly preferred deterioration inhibitors include butyrated hydroxytoluene (BHT). The ultraviolet inhibitor is described in JP-A-7-11056.

The cellulose acetate film is preferably subjected to a surface treatment. Specific examples of the surface treatment include a corona discharge treatment, a glow discharge treatment, a flame treatment, an acid treatment, an alkali treatment and an ultraviolet irradiation treatment. It is also preferred to provide an undercoat layer as described in JP-A-7-333433.

In these treatments, from the standpoint of keeping the planarity of film, the temperature of the cellulose acetate film is preferably set to Tg (glass transition temperature) or less, specifically, 150° C. or less.

In view of adhesion to the alignment film or the like, the surface treatment of the cellulose acetate film is preferably an acid treatment or an alkali treatment, namely, a saponification treatment to the cellulose acetate film.

The surface treatment is described in detail below by referring to the alkali saponification treatment as an example.

The alkali saponification treatment is preferably performed by a cycle such that the film surface is dipped in an alkali solution, neutralized with an acidic solution, washed with water and dried. Examples of the alkali solution include a potassium hydroxide solution and a sodium hydroxide solution. The normality of hydroxide ion is preferably from 0.1 to 3.0 N, more preferably from 0.5 to 2.0 N. The temperature of the alkali solution is preferably from room temperature to 90° C., more preferably from 40 to 70° C.

The surface energy of the cellulose acetate film is preferably 55 mN/m or more, more preferably from 60 to 75 mN/m.

The surface energy can be determined by the same method as the method described above for calculating the surface energy of the optically anisotropic layer.

The thickness of the cellulose acetate film is usually from 5 to 500 μm, preferably from 20 to 250 μm, more preferably from 30 to 180 μm, still more preferably from 30 to 110 μm.

Use of Retardation Film:

The retardation film of the present invention can be used as an elliptically polarizing film by combining it with a polarizing film. Furthermore, when applied in combination with a polarizing film to a transmission-type, reflection-type or transflection-type liquid crystal display device, the retardation film contributes to the enlargement of view angle.

The elliptically polarizing film and liquid crystal display device using the retardation film of the present invention are described below.

Elliptically Polarizing Film:

An elliptically polarizing film can be produced by stacking the retardation film of the present invention and a polarizing film. By the use of the retardation film of the present invention, an elliptically polarizing film capable of enlarging the view angle of a liquid crystal display device can be provided.

The polarizing film includes an iodine-type polarizing film, a dye-type polarizing film using a dichroic dye, and a polyene-type polarizing film. The iodine-type polarizing film and dye-type polarizing film are generally produced using a polyvinyl alcohol-base film. The polarization axis of polarizing film corresponds to the direction perpendicular to the stretching direction of the film.

The polarizing film is stacked on the optically anisotropic layer side of the retardation film. On the surface of the polarizing film opposite the side where the retardation film is stacked, a transparent protective film is preferably formed. The transparent protective film preferably has a light transmittance of 80% or more. For the transparent protective film, a cellulose ester film is generally used and a triacetyl cellulose film is preferred. The cellulose ester film is preferably formed by a solvent casting method. The thickness of the transparent protective film is preferably from 20 to 500 μm, more preferably from 50 to 200 μm.

Liquid Crystal Display Device:

By the use of the retardation film of the present invention, a liquid crystal display device enlarged in the view angle can be provided. The retardation film (optical compensatory (or compensation) sheet) for TN-mode liquid crystal cells is described in JP-A-6-214116, U.S. Pat. Nos. 5,583,679 and 5,646,703 and German Patent Publication No. 3911620A1. The optical compensatory sheet for IPS-mode or FLC-mode liquid crystal cells is described in JP-A-10-54982, the optical compensatory sheet for OCB-mode or HAN-mode liquid crystal cells is described in U.S. Pat. No. 5,805,253 and International Patent Publication No. WO96/37804, the optical compensatory sheet for STN-mode liquid crystal cells is described in JP-A-9-26572, and the optical compensatory sheet for VA-mode liquid crystal cells is described in Japanese Patent 2,866,372.

In the present invention, the retardation film (optical compensatory sheet) for liquid crystal cells in various modes can be produced by referring to those patent publications. The retardation film of the present invention can be used for liquid crystal display devices in various display modes such as TN (twisted nematic) mode, IPS (in-plane switching) mode, FLC (ferroelectric liquid crystal) mode, OCB (optically compensatory bend) mode, STN (super twisted nematic) mode, VA (vertically aligned) mode and HAN (hybrid aligned nematic) mode.

The liquid crystal display device comprises a liquid crystal cell, a polarizing element and a retardation film (optical compensatory sheet). The polarizing element generally comprises a polarizing film and a protective film. As for the polarizing film and protective film, those described above regarding the elliptically polarizing film can be used.

The present invention is described below by referring to Examples, however, the present invention is not limited to these Examples.

### EXAMPLE 1

(Production of Transparent Support)

The following components are charged into a mixing tank and stirred under heating to prepare a cellulose acetate solution (dope).

(Composition of Cellulose Acetate Solution)

| | | |
|---|---|---|
| Cellulose acetate having an | 100 | parts by mass |
| acetylation degree of 60.9% | | |
| Triphenyl phosphate | 6.5 | parts by mass |
| Biphenyl diphenyl phosphate | 5.2 | parts by mass |
| Retardation Increasing Agent | 0.1 | part by mass |
| (1) shown below | | |
| Retardation Increasing Agent | 0.2 | part by mass |
| (2) shown below | | |
| Methylene chloride | 310.25 | parts by mass |
| Methanol | 54.75 | parts by mass |
| 1-Butanol | 10.95 | parts by mass |

Retardation Increasing Agent (1):

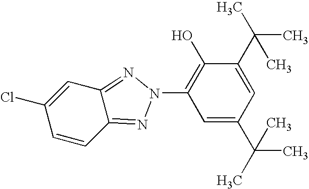

Retardation Increasing Agent (2):

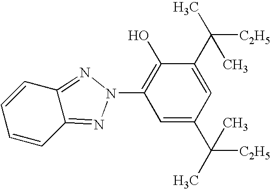

The dope prepared above is cast from a casting port on a drum cooled to 0° C. The film formed is peeled off in the state having a solvent content of 70 mass %. Both edges in the cross direction of the film are fixed by a pin tenter and the film is dried while keeping the distance of giving a stretching percentage of 3% in the cross direction (the direction perpendicular to the longitudinal direction) in the region where the solvent content is from 3 to 5 mass %. Thereafter, the film is further dried by transporting it between rollers of a heat-treating device and adjusted such that the stretching percentage in the longitudinal direction becomes substantially 0% in the region exceeding 120° C. and the ratio of the stretching percentage in the cross direction to the stretching percentage in the longitudinal direction becomes 0.75 (by taking account of stretching of 4% in the longitudinal direction at the peeling). In this way, a cellulose acetate film having a thickness of 100 μm is produced. The retardation of the produced film is measured at a wavelength of 632.8 nm, as a result, the retardation in the thickness direction of the film produced is 40 nm and the in-plane retardation is 4 nm. The produced cellulose acetate film is used as the transparent support.

(Formation of First Undercoat Layer)

On the transparent support, a coating solution having the following composition is coated to a coverage of 28 ml/m² and dried to form a first undercoat layer.

(Composition of Coating Solution for First Undercoat Layer)

| | |
|---|---|
| Gelatin | 5.42 parts by mass |
| Formaldehyde | 1.36 parts by mass |
| Salicylic acid | 1.60 parts by mass |
| Acetone | 391 parts by mass |
| Methanol | 158 parts by mass |
| Methylene chloride | 406 parts by mass |
| Water | 12 parts by mass |

(Formation of Second Undercoat Layer)

On the first undercoat layer, a coating solution having the following composition is coated to a coverage of 7 ml/m² and dried to form a second undercoat layer.

(Composition of Coating Solution for Second Undercoat Layer)

| | |
|---|---|
| Anionic polymer shown below | 0.79 parts by mass |
| Monoethyl citrate | 10.1 parts by mass |
| Acetone | 200 parts by mass |
| Methanol | 877 parts by mass |
| Water | 40.5 parts by mass |

Anionic Polymer:

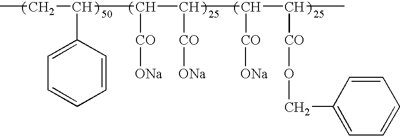

(Formation of Back Layer)

On the opposite surface of the transparent support, a coating solution having the following composition is coated to a coverage of 25 ml/m² and dried to form a back layer.

(Composition of Coating Solution for Back Layer)

| | |
|---|---|
| Cellulose diacetate having an | 6.56 parts by mass |
| acetylation degree of 55% | |
| Silica-base matting agent | 0.65 parts by mass |
| (average particle size: 1 μm) | |
| Acetone | 679 parts by mass |
| Methanol | 104 parts by mass |

(Formation of Alignment Film)

An acrylic acid copolymer (PA310) shown below and triethylamine are dissolved in a methanol/water mixed solvent (volume ratio=30/70) such that the triethylamine becomes 20 wt % based on the acrylic acid copolymer, whereby a 5 wt % solution is prepared.

Acrylic Acid Polymer (PA310)

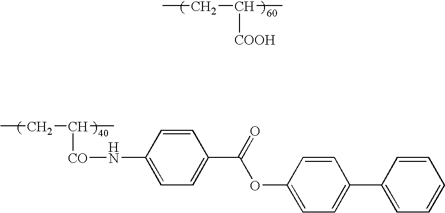

The solution prepared above is coated on the second undercoat layer, dried with hot air of 100° C. for 5 minutes and then rubbed to form an alignment film. The thickness of the obtained alignment film is 0.5 μm. The rubbing direction of the alignment film is parallel to the casting direction of the transparent support.

(Formation of Optically Anisotropic Layer)

On the alignment film obtained by rubbing, a coating solution for optically anisotropic layer having the following composition is coated using a #4 wire bar.

(Coating Solution for Optically Anisotropic Layer)

| | | |
|---|---|---|
| Biaxial Liquid Crystalline | 100 | parts by mass |
| Compound m-3 | | |
| Air Interface Orientation | 0.2 | parts by mass |
| Controlling Agent V-(1) shown | | |
| below | | |
| Photopolymerization Initiator | 2.0 | parts by mass |
| HJ-1 shown below | | |
| Lucirin TPO-L (produced by | 2.0 | parts by mass |
| BASF) | | |
| Methyl ethyl ketone | 300 | parts by mass |

Air Interface Orientation Controlling Agent V-(1)

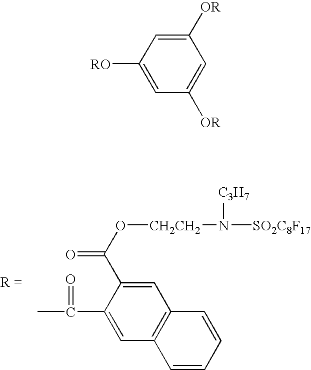

Photopolymerization Initiator HJ-1:

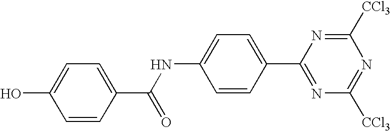

After the optically anisotropic layer is coated, the film is placed in a thermostatic chamber at 60° C. and heated over about 20 seconds until the film temperature reached 50° C. The film is kept intact for 1 minute and then placed in a thermostatic chamber at 60° C. having an oxygen concentration of 2%. After 30 seconds, an ultraviolet ray of 600 mJ/cm² is irradiated to fix the orientation state of the optically anisotropic layer and then the film is allowed to cool to room temperature, thereby producing a retardation film. The thickness of the optically anisotropic layer is 1.82 μm.

The biaxiality and tilt angle in the optically anisotropic layer of the obtained retardation film are judged by using a polarizing microscope with a free plate. As a result, it is confirmed that the optically anisotropic layer exhibits biaxiality and the direction having a minimum refractive index and the direction having a maximum refractive index are substantially orthogonal to the normal direction of the transparent support.

### EXAMPLE 2

(Formation of Alignment Film)

An acrylic acid copolymer (PA732) shown below and triethylamine are dissolved in a methanol/water mixed solvent (volume ratio=30/70) to prepare a 4 mass % solution.

(PA732)

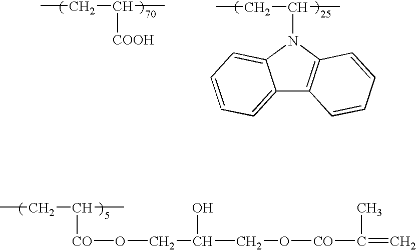

The solution prepared above is coated on a glass substrate and dried with hot air of 120° C. for 5 minutes and then the surface thereof is rubbed to form an alignment film. The thickness of the obtained alignment film layer is 0.5 μm.

(Formation of Optically Anisotropic Layer)

On the alignment film obtained above by rubbing, a coating solution for optically anisotropic layer having the following composition is coated by using a spin coater.

(Coating Solution for Optically Anisotropic Layer)

| | |
|---|---|
| Liquid Crystal Compound (D-1) | 33 parts by mass |
| shown below | |
| Liquid Crystal Compound (C-1) | 10 parts by mass |
| shown below | |
| Chloroform | 700 parts by mass |

(D-1)

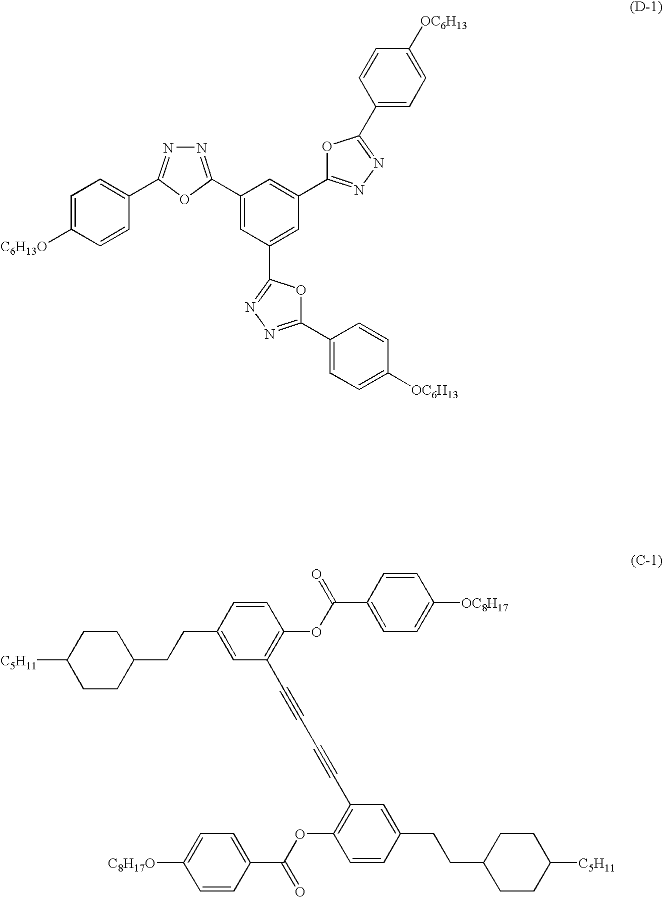

The glass substrate having coated thereon the optically anisotropic layer is heated to 160° C. on a hot stage and after lowering the temperature to 102° C., held for 3 minutes. Thereafter, the glass substrate is rapidly cooled to −70° C. to produce a retardation film. The thickness of the optically anisotropic layer is 0.8 μm.

The biaxiality and tilt angle in the optically anisotropic layer of the obtained retardation film are judged by using a polarizing microscope with a free pedestal. As a result, it is confirmed that the optically anisotropic layer is exhibiting biaxiality and the direction having a minimum refractive index and the direction having a maximum refractive index are nearly orthogonal to the normal direction of the transparent support.

### COMPARATIVE EXAMPLE 1

(Formation of Alignment Film)

A modified polyvinyl alcohol shown below and glutaraldehyde (5 mass % of the modified polyvinyl alcohol) are dissolved in a methanol/water mixed solvent (volume ratio=20/80) to prepare a 5 mass % solution.

Modified Polyvinyl Alcohol:

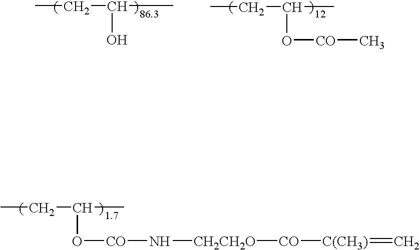

The solution prepared above is coated on the second undercoat layer in the transparent support obtained by Example 1, dried with hot air of 100° C. for 120 seconds and then rubbed to form an alignment film layer. The thickness of the obtained alignment film layer is 0.5 μm. The rubbing direction of the alignment film is parallel to the casting direction of the transparent support.

(Formation of Optically Anisotropic Layer)

On the alignment film obtained by rubbing, a coating solution for optically anisotropic layer having the following composition is coated using a #4 wire bar.

(Coating Solution for Optically Anisotropic Layer)

| | | |
|---|---|---|
| Biaxial Liquid Crystalline | 100 | parts by mass |
| Compound m-3 | | |
| Air Interface Orientation | 0.2 | parts by mass |
| Controlling Agent V-(2) shown | | |
| below | | |
| Photopolymerization Initiator | 2.0 | parts by mass |
| HJ-1 shown below | | |
| Lucirin TPO-L (produced by | 2.0 | parts by mass |
| BASF) | | |
| Methyl ethyl ketone | 300 | parts by mass |

Air Interface Orientation Controlling Agent V-(2):

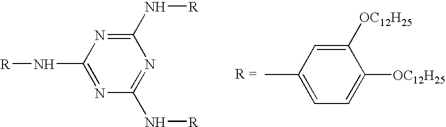

After the optically anisotropic layer is coated, the film is placed in a thermostatic chamber at 60° C. and heated over about 20 seconds until the film temperature reached 50° C. The film is kept intact for 1 minute and then placed in a thermostatic chamber at 60° C. having an oxygen concentration of 2%. After 30 seconds, an ultraviolet ray of 600 mJ/cm² is irradiated to fix the orientation state of the optically anisotropic layer and then the film is allowed to cool to room temperature, thereby producing a retardation film. The thickness of the optically anisotropic layer is 1.82 μm.

The biaxiality and tilt angle in the optically anisotropic layer of the obtained retardation film are judged by using a polarizing microscope with a free plate. As a result, it can be confirmed that the optically anisotropic layer exhibits biaxiality and the direction having a minimum refractive index is almost the same as the normal direction of the transparent support.

As shown in Examples 1 and 2, a retardation film having an optically anisotropic layer which exhibits biaxiality and in which the direction having a minimum refractive index is substantially orthogonal to the normal direction of the transparent support can be obtained.

In Comparative Example 1 using a polyvinyl alcohol-base alignment film, an optically anisotropic layer where the direction having a minimum refractive index is substantially orthogonal to the normal direction of the transparent support cannot be obtained. From these, it is seen that the refractive index direction of the optically anisotropic layer can be controlled, for example, by changing the composition of the alignment film.

According to the present invention, a retardation film having an optical property such that the direction having a minimum refractive index of the optically anisotropic layer is substantially orthogonal to the normal direction in the film plane can be provided by using a biaxial liquid crystal compound without performing a stretching operation. Also, an elliptically polarizing film using the retardation film can be provided.

This application is based on Japanese patent application JP 2003-035454, filed on Feb. 13, 2003, the entire content of which is hereby incorporated by reference, the same as if set forth at length.

What is claimed is:

1. A retardation film comprising:
a transparent support positioned in a plane; and
at least one optically anisotropic layer having a first direction with a smallest refractive index,
wherein said at least one optically anisotropic layer is formed of at least one compound exhibiting a liquid crystal phase; said at least one optically anisotropic layer exhibits biaxiality; and the first direction is substantially orthogonal to a direction normal to the plane of the transparent support.

2. The retardation film as claimed in claim 1, wherein the liquid crystal phase is a biaxial liquid crystal phase.

3. The retardation film as claimed in claim 2, wherein the biaxial liquid crystal phase is a biaxial nematic liquid crystal phase.

4. The retardation film as claimed in claim 1, wherein said at least one optically anisotropic layer has a second direction with a largest refractive index, and the second direction is substantially orthogonal to a direction normal to the plane of the transparent support.

5. The retardation film as claimed in claim 1, wherein said at least one optically anisotropic layer has a support-side interface and an air interface; an angle defined by the first direction and the normal direction of the transparent support is from 75° to 105° at both of the support-side interface and the air interface; and an angle defined by the second direction and the normal direction of the transparent support is from 75° to 105° at both of the support-side interface and the air interface.

6. The retardation film as claimed in claim 4, which further comprises an alignment film between the transparent layer and said at least one optically anisotropic layer.

7. The retardation film as claimed in claim 2, wherein the compound exhibiting the biaxial liquid crystal phase is at least one of a polymerizable compound and a polymer compound.

8. The retardation film as claimed in claim 6, wherein the alignment film comprises a polymer having at least one of a hydrophobic group and an exclude-volume group.

9. The retardation film as claimed in claim 8, wherein the polymer comprises an acrylic or methacrylic acid copolymer comprising a repeating unit represented by the following formula (I) and a repeating unit represented by the following formula (II) or (III): 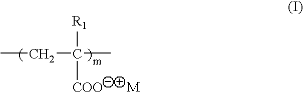 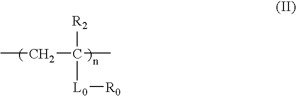 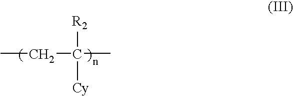
wherein R₁ represents a hydrogen atom or a methyl group; R₂ represents a hydrogen atom, a halogen atom or an alkyl group having from 1 to 6 carbon atoms; M represents a proton, an alkali metal ion or an ammonium ion; L₀ represents a divalent linking group selected from the group consisting of —O—, —CO—, —NH—, —SO₂—, an alkylene group, an alkenylene group, an arylene group and a combination thereof; R₀ represents a hydrocarbon group having from 10 to 100 carbon atoms or a fluorine atom-substituted hydrocarbon group having from 1 to 100 carbon atoms; C_{y} represents an aliphatic ring group, an aromatic group or a heterocyclic group; m is from 10 to 99 mol %; and n is from 1 to 90 mol %.

10. The retardation film as claimed in claim 1, wherein said at least one optically anisotropic layer is not stretched.

11. An elliptically polarizing film comprising a retardation film claimed in claim 1 and a polarizing film.
